(19) United States
(12) Patent Application Publication
(10) Pub. No.: US 2021/0216049 A1
(43) Pub. Date: Jul. 15, 2021

(54) AUTONOMOUS CONTROL SYSTEM AND METHOD USING EMBODIED HOMEOSTATIC FEEDBACK IN AN OPERATING ENVIRONMENT

(71) Applicant: ThoughtForge Inc., Berkeley, CA (US)

(72) Inventor: Mathew James Brown, Berkeley, CA (US)

(73) Assignee: ThoughtForge Inc., Berkeley, CA (US)

(21) Appl. No.: 17/144,014

(22) Filed: Jan. 7, 2021

Related U.S. Application Data
(60) Provisional application No. 62/959,122, filed on Jan. 9, 2020.

(51) Int. Cl. G05B 13/02; G05B 13/04

(52) U.S. Cl. CPC G05B 13/027; G05B 13/048

(57) ABSTRACT

A machine-learning control system comprising an operating environment and a sensorium informationally coupled the operating environment. The sensorium comprises a set of sensors and a set of motors, both informationally coupled to a homeostatic network capable of achieving ultrastability within the operating environment. The control system builds a generative model of the operating environment by extracting, through sensorimotor feedback, state information relevant to network ultrastability associated with a particular control behavior and a set of environmental parameters identified within the operating environment. A modulating sensorimotor carrier wave signal may optionally be used to increase training speed of the machine-learning control system. The control system is adaptable to a variety of engineering solutions for autonomous control systems and data processing, such as, for example, autonomous vehicles, robotics, calibration, language processing, and computer vision. A homeostatic network debugger and automatic network topology generation algorithms using node-splitting conditions and functions are also described.

### CROSS-REFERENCE TO RELATED APPLICATIONS

This application claims the benefit of U.S. Provisional Application No. 62/959,122, titled “Autonomous Control System And Method Using Embodied Homeostatic Feedback In An Operating Environment,” filed Jan. 9, 2020, which is hereby incorporated herein by reference in its entirety for all purposes.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### I. Technology Field

The innovations described herein generally relate to the field of artificial neural networks and, more particularly, to implementations of network nodes that employ recurrence and feedback mechanisms in adaptive networks for solving general control problems using machine-learning systems and methods.

### II. Description of Related Art

A physical device called the “Homeostat” built by W. Ross Ashby in the 1950's (see Design for a Brain, Ashby, John Wiley & Sons, New York, 1954, pp. 93-102) provides relevant background to the subject matter described herein. Ashby's Homeostat was a physical analog device constructed from recycled World War II bomb equipment. This homeostatic device demonstrated a characteristic now known as ultrastability (as prescribed by Ashby), which was used to generate adaptation of the device within an operating environment. (A discussion of “The Ultrastable System” can be found in Ashby's Design For A Brain, supra, pp. 90-93).

Most machine-learning models today, such as Deep Reinforcement Learning models, are based on analytical models, loss-functions and the like. Usually, these analytical models are based on some property in the brain considered necessary for learning. For example, with respect to applications for neural networks, the original Rosenblatt Perceptron omitted state from its neural model because neuroscience knowledge at the time (1940's) suggested biological neurons were stateless. As a result, traditional neural network models are generally envisioned as stateless input-output mappings.

This prior approach to machine-learning neural network paradigms assumes that all learned information is contained in the weights of network node connections. Drawbacks inherent to this approach, and with respect to their use in engineering applications, include, at the very least, computational burdens relating to (1) the amount of data required, (2) the amount of computational hardware required, (3) the complexity of algorithms required, and (4) lack of meaningful scalability of the system.

Other prior approaches, such as those that use reinforcement-like feedback in neural network training paradigms, are similarly limited, and do not provide meaningful solutions to achieve complex learned behaviors, such as object avoidance, navigation through obstacles, or pursuit of complex goals. For example, U.S. Pat. No. 10,469,019 exemplifies prior approaches that describe neural network systems aimed to detect failure conditions or to optimize motor performance with respect to very restricted environmental conditions; the output behaviors of those neural network systems are simplistic and non-adaptive, and therefore too limited to offer solutions to complex autonomous control problems and data processing challenges, such as, for example, those arising in the areas of self-driving vehicles, robotics, and data handling (compression, analysis, etc.).

Other proposed systems (such as described in U.S. Pat. No. 9,224,090) suggest the use of “spiking neural networks,” which make use of relative spike-timing between network nodes to update connections within a neural network, but still provide very limited solutions, restricted to simplistic problems solved with traditional, feed-forward neural network models.

Yet other prior approaches merely suggest abstract concepts (e.g., theoretical use of autopoiesis for self-maintenance, as described in U.S. Pat. No. 8,983,883), but without teaching how to implement those concepts in a machine-learning control system for general use and, in particular, for application that provide solutions to real-world problems.

These prior approaches intentionally avoid—and thus underscore—the complexity that arises in the field of artificial intelligence with the use of recurrence and feedback within and among neural network nodes, where a fully-connected neural network of size three or greater is usually analytically intractable. The function of such a system depends upon chaotic dynamics that are nondeterministic, and thus problematic for real-world systems applications. Thus, what is needed is a system and method for machine-learning that alleviates the computational burdens and apparent intractability of prior art systems. It is therefore desirable to have a machine-learning system that efficiently overcomes the limitations of those prior art systems, thereby achieving meaningful, technical feasibility of a machine-learning control system that can be employed in a wide range of complex and real-world applications, such as data signal processing, robotics, autonomous vehicles, calibration and autonomous control systems generally, among others.

### SUMMARY

A glossary of particular terms used herein is provided below, following the detailed description of the systems and methods of the present subject matter. A system of one or more computers can be configured to perform particular operations or actions by virtue of having software, firmware, hardware, or a combination of them installed on the system that, in operation, causes or cause the system to perform the operations or actions. One or more computer programs can be configured to perform particular operations or actions by virtue of including instructions that, when executed by a data processing apparatus, cause the apparatus to perform the operations or actions. One general aspect of the implementation described herein includes a method of implementing a machine-learning control system by: (1) identifying, in a data processing system, an operating environment comprising a set of environmental parameters and a control behavior; (2) defining, in the data processing system, a sensorium informationally coupled to the set of environmental parameters within the operating environment, wherein the sensorium comprises at least one motor and at least one sensor; and (3) informationally coupling, in the data processing system, a homeostatic network to the at least one sensor and to the at least one motor, wherein the homeostatic network comprises a plurality of network nodes operable to achieve ultrastability associated with the control behavior within the operating environment. Other embodiments of this aspect include corresponding data structures, computer systems, apparatus, and computer programs recorded on one or more computer storage devices, each configured to perform and/or facilitate the actions of the methods.

Implementations may include one or more of the following features: The method may include modulating signals in the sensorium; the method may include defining an update rate of the sensorium; and/or at least one node in the plurality of nodes is individually configured to achieve ultrastability within the operating environment. At least one node in the plurality of nodes may include a data structure, such as a list operable to store a set of connected nodes and a corresponding set of connection weights, and a memory location operable to store an accumulated prediction error, where the accumulated prediction error is computed from the corresponding set of connection weights and used by the at least one motor to determine a local state information signal of the at least one node. In some aspects, modulating signals in the sensorium may include using a sensorimotor carrier wave signal. Implementations of the described techniques may include hardware, a method or process, or computer software on a computer-accessible medium.

Implementations may include an autonomous control system, such as a stability control system, which may include at least one sensorimotor carrier wave signal operable to modulate signals in the sensorium. The sensorium further may include an update rate relative to the operating environment. The autonomous control system may include means for updating the network. Implementations of the described techniques may include hardware, a method or process, or computer software on a computer-accessible medium.

One general aspect includes a method for generating a data structure representing a plurality of nodes in a network of nodes, and for generating at least one split condition signal relating to a node in the plurality of nodes, and performing at least one split function conditionally upon the at least one split condition signal and operable to generate at least one additional node in the plurality of nodes. Other embodiments of this aspect include corresponding computer systems, apparatus, and computer programs recorded on one or more computer storage devices, each configured to perform the actions of the methods.

Implementations may further include a non-transitory computer-readable medium embodying a method of machine-learning using an active inference process which may include: initializing randomly a node in a network to determine a generative model of an operating environment; evaluating the generative model based upon an accumulated prediction error computed at the node; determining whether the generative model causes the accumulated prediction error at the node to exceed a threshold value; and generating a set of random connection weights when the accumulated prediction error at the node exceeds the threshold value. The network may be a homeostatic network. Implementations of the described techniques may include hardware, a method or process, or computer software on a computer-accessible medium.

One further aspect includes a homeostatic network debugger apparatus operable to generate a homeostat display, a sensorimotor display, a set of simulation time controls, a network layout render, and an environment display window. Other embodiments of this aspect include corresponding data structures, computer systems, apparatus, and computer programs recorded on one or more computer storage devices, each configured to perform and/or facilitate the actions of the methods.

Thus, a machine-learning control system that learns by seeking homeostatic equilibrium with an operating environment is described. While the machine-learning control system reaches homeostatic equilibrium, it is receptive to feedback through the operating environment via sensorimotor coupling. Machine-learning in the control system is accomplished by using one or more inferences about the operating environment. The machine-learning control system builds a generative model of the operating environment by extracting, through sensorimotor feedback, semantic information corresponding to information relevant to self-perpetuation of nodes within a homeostatic network of chaotic attractors. The machine-learning control system described herein can be applied to a variety of autonomous control problems in engineering applications with sensor data sources.

The system and method described herein provides an efficient and improved design solution for building autonomous control systems for various commercial and industrial control engineering applications, such as autonomous vehicles, robotics, calibration, natural language processing, and computer vision; it can also be adapted for other related processes, such as data compression systems, anomaly detection and prediction systems. A homeostatic network debugger apparatus is also provided.

### BRIEF DESCRIPTION OF THE DRAWINGS

Further features, the nature, and various advantages of the disclosed subject matter will be more apparent from the following detailed description and the accompanying drawings in which:

FIG. 1A is a schematic illustration of a high-level relationship between an operating environment and a sensorium of the machine-learning control system described herein.

FIG. 1B is a schematic illustration of various components that make up the sensorium and the operating environment in one aspect of the machine-learning control system described herein.

FIG. 2 is a schematic illustration of an example network layout in a homeostatic network of one aspect of the sensorium, and its informational coupling to the operating environment.

FIG. 3A is a schematic illustration of a local implementation for an ultrastable node of one aspect of the homeostatic network of the sensorium.

FIGS. 3B and 3C are schematic illustrations of one aspect of data structures for storing a list of homeostatic network nodes (FIG. 3B); in this aspect, each homeostatic node (FIG. 3C) stores a connection list of neighboring nodes and their corresponding connection weights, and an accumulated prediction error, which is updated during learning.

FIG. 4A is a flowchart depicted general steps of active inference in one aspect of the described subject matter.

FIGS. 4B and 4C are schematic illustrations of a series of example diagrams to further illustrate the learning effect in general aspects of the described subject matter.

FIG. 5A is a schematic illustration of a general aspect of the sensorium comprising a process for normalizing and/or modulating signals in sensorium according to one aspect of the described subject matter.

FIG. 5B is a schematic illustration of a general aspect of modulating signals in the sensorium using a sensorimotor carrier wave signal to generate a sensor signal according to one aspect of the described subject matter.

FIG. 5C is a schematic illustration of a general aspect of demodulating signals in the sensorium using a sensorimotor carrier wave signal to generate a motor signal according to one aspect of the described subject matter.

FIGS. 6A, 6B, 6C, 6D, 6E, 6F and 6G are schematic illustrations of several types of sensorimotor informational coupling of sensors to a homeostatic network to an operating environment using a sensorimotor carrier wave to modulate signals in the sensorium.

FIG. 7 is a schematic illustration of sensorimotor informational coupling of motors to a homeostatic network to an operating environment.

FIGS. 8A and 8B are flowcharts depicting two related aspects of algorithms that may be implemented in executable code embodied in a non-transitory computer storage medium which, when executed in a data processing system, performs a method of the subject matter described herein.

FIG. 9 is a schematic illustration of an example homeostatic network configuration chosen to solve the Cartpole problem using one aspect of the described subject matter.

FIG. 10 is a flowchart depicting one aspect of an algorithm that may be implemented in executable code embodied in a non-transitory computer storage medium which, when executed in a data processing system, performs a method for automatic generation of a network topology according to one aspect of the subject matter described herein.

FIG. 11 is a schematic illustration of how automatic network topology generation may be achieved using Split Conditions and Split Functions as one aspect of a network node update process.

FIGS. 12A, 12B, 12C and 12D are schematic illustrations of various examples of Split Functions in some aspects of the described subject matter utilizing methods for automatic generation of a network topology.

FIG. 13 is a schematic illustration of a high-level structure of a data-compression configuration of the described subject matter.

FIG. 14 is a schematic illustration of one aspect of the described subject matter, wherein the operating environment is a Sequential Data Sensorimotor Harness, in an application used for data processing, such as data compression.

FIG. 15 is a schematic illustration of a Sequential Data Sensorimotor Harness of one aspect of the described subject matter teaching a homeostatic network to reproduce a data source.

FIG. 16 is a schematic illustration of one aspect of the user interface of a homeostatic debugger apparatus for the described subject matter.

FIG. 17 is a schematic illustration of dataflow for one aspect of a homeostatic debugger for the described subject matter.

FIG. 18 is a schematic illustration of one aspect of a Network Layout Render for the described subject matter.

FIG. 19 is a schematic illustration of a flowchart of one aspect of the described subject matter.

FIG. 20 is a schematic illustration of a flowchart of the general structure of one aspect of the described subject matter.

FIG. 21 is a schematic illustration showing further implementation details for a sensorium according to some aspects of the described subject matter.

FIG. 22 is a schematic illustration of the basic structure of a homeostatic network created using a node layer according to one aspect of the described subject matter.

FIGS. 23A and 23B are schematic illustrations of data structures used in several aspects of the described subject matter.

FIGS. 24A, 24B and 24C are schematic illustrations of example hardware components suitable for implementing certain aspects of the disclosed subject matter.

### DETAILED DESCRIPTION

### I. Overview

A. Holonic Function Of Homeostatic Nodes

The use of homeostatic network nodes, which employ recurrence and feedback mechanisms for adaptation, in real-time adaptive networks for solving general control problems using active inferences about an operating environment is described herein. In one aspect of the described subject matter, homeostatic nodes are interconnected in a “homeostatic network,” in which homeostatic nodes are periodically updated and operate on local state and incoming signals. Unlike traditional neural network solutions to engineering challenges which depend upon back propagation for training, the homeostatic nodes of the present subject matter perform as chaotic attractors that collectively or individually implement a property known as ultrastability. Ultrastability refers to the ability of a system to modify internal relationships among its constituents, and/or to influence environmental conditions, in order to neutralize actual or potential destabilizing events or obstacles within (or relating to) an operating environment, thereby maintaining stability. Maintaining stability, in the context of the system and method described herein, implies keeping an accumulated prediction error within a threshold value. By building networks of ultrastable nodes as described herein, sensory data can be projected in high-dimensions and back into lower-dimensions, in various ways, by changing weights of homeostatic node interconnections, which in turn changes the flow of information through the homeostatic network. In some aspects, as described in further detail below, overlapping subnetworks in a homeostatic network represent distinct attractor dynamics in superposition; these subnetworks may express themselves differently based on global network dynamics and environmental change, as detected through sensors. The ability to achieve ultrastability, as described herein, provides a mechanism for an autonomous control system to respond to destabilization through internal weight changes within a homeostatic network of nodes, as described herein.

B. Structural Difference from Traditional Neural Networks: Introduction of a State

For the purposes of implementing homeostatic nodes, such as those in the described subject matter, a node is chaotic attractor having a state that generates ultrastability and also tracks the node's accumulated prediction error. Thus, in one aspect, an accumulated prediction error is used for determining whether a node's state is stable within the context of a global homeostatic network embodied in a machine-learning control system. Introduction of a node's state renders back- and forward-propagation methods for learning unnecessary. Implementation of network node states introduces time as an inherent component of the learning process.

C. Structural Difference from Traditional Neural Networks: Removal of Explicit Activation Functions

The original Rosenblatt Perceptron added the concept of Activation Functions, because it was believed that a combination of (stateless) linear transformations could never learn, since it lacked nonlinearities. Activation Functions were therefore added to introduce nonlinearities, and they are still widely used in traditional neural networks. In stark contrast, one aspect of the described subject matter demonstrates, however, that nonlinearities can be introduced into a machine-learning control system when it embodies a homeostatic network—for example, a weight function itself can vary over time—and thus Activation Functions need not be used in such aspects. More details on specific implementations of such beneficial aspects of the described subject matter are provided below.

D. Sensorimotor Coupling and Modulation Methods

While learning may still occur with direct, unmodulated sensorimotor couplings between an operating environment and a homeostatic network, using modulation in those sensorimotor couplings can serve to increase training speed. More details on specific implementations of aspects of the described subject matter are provided below.

E. Learning Occurs Through Chaotically Randomly-Generating Network Connection Weights

When a neural network is at a global equilibrium, it is effectively not learning anymore, because it is able to successfully predict sensorial inputs based on its internal model of the world. When an individual node in the network destabilizes, this likely occurs because its local self-prediction error has exceeded a pre-defined threshold. In order to re-stabilize, one aspect of the described subject matter includes chaotic and random generation of network node connection weights.

In one aspect, when a network node resets its weights, the node is basically choosing a new linear transformation. However, the phase-space in which this node is performing a re-projection is defined by the rest of the nodes in the network, and how this particular node is connected to them. This condition imposes a constraint on the resetting-node which confines its exploration to a part of the higher-dimensional phase space it occupies, as defined by the global network.

In one aspect of the described subject matter, each network node is performing a resetting process continuously and in parallel with other nodes in the network, so the higher-dimensional phase space of solutions is explored as a finite collection of low-dimensional searches, which holonically function as a higher-dimensional search. The homeostatic network of the described subject matter generates behaviors that extend outward from the network through one or more motors, and to the operating environment, and then and back into one or more sensors. The amount of control this network has over its environment is dependent on the complexity of behaviors it can generate.

### II. Various Aspects

A. Sensorimotor Coupling

The machine-learning control system described herein uses entropy in the system to drive a chaotic exploration process. In one aspect, the machine-learning control system includes a sensorimotor coupling component and an operating environment, which may be a virtual or simulated environment. One or more environmental parameters are informationally coupled to one or more sensors and one or more motors, which are themselves connected (either directly or indirectly) to a network of homeostatic nodes. Coupling the network of homeostatic nodes to the operating environment includes the use of modulated sensors and motors, such as, for example, amplitude-, phase-, and/or frequency-modulated input/output devices.

In one aspect, a sensorimotor carrier wave is used for modulating signals of the sensorium's sensors and motors, and may act as a phase-space constraint that propagates a signal through the network very quickly, thereby accelerating adaptation. In a further aspect, the sensorimotor carrier wave comprises a combination of amplitude modulation and frequency modulation. In a third aspect, the sensors and/or motors are first modulated by frequency, and afterwards modulated again by amplitude.

In one aspect, structural components of the machine-learning control system may include:
1. An externally-supplied environment (environmental parameters) and a problem to solve (desired control behavior); and
2. A sensorium, comprising:
   a. Sensor and motor definitions;
   b. One or more sensorimotor carrier wave frequencies;
   c. At least one sensorimotor update rate, relative to the externally-supplied environment; and
   d. A homeostatic network, which itself comprises a set of sparse, high-dimensional cellular automata of chaotic attractors, capable of achieving ultrastability.

Thus, in one aspect, an operating environment interacts with one or more sensors and one or more motors, which together enable the machine-learning control system of the described subject matter to solve an operating environmental problem, by learning to anticipate sensorial feedback from motor actions, thereby minimizing destabilizing influences of the sensors.

As used herein, sensors and motors broadly mean general input and output elements that produce or transmit signals within and between the operating environment and the homeostatic network. These signals can be interpreted in many ways, usually represented as a numerical value, but for simplicity, the terms “sensor” and “motor” mean “input” and “output” signal generators, respectively. The sensors and motors, as described herein, thus act as interfaces between an operating environment and a homeostatic network of a machine-learning control system according to the described subject matter.

Information input to the machine-learning control system comprises a specified operating environment, one or more sensor definitions, one or more motor definitions, and a problem to be solved. The result output of the machine-learning control system comprises at least one homeostatic network trained to operate as an agent embedded within the specified operating environment. When embedded in the specified operating environment, the resulting trained homeostatic network can maintain critical state when coupled to an unknown operating environment, because it is able to converge faster than the unknown operating environment can destabilize it.

Successfully-constructed internal relationships accumulate via feedback loops through motors, the operating environment and back into the sensors. System behaviors are stored by becoming entrained in global, feedback loops, and may be re-executed when the homeostatic network senses a familiar operating environment. This aspect is an implementation of auto-associative behavior recall, or auto-associative memory.

In a general aspect, the resulting trained homeostatic network comprises a specific network topology (nodes, connections and weights) as well as informational signals propagating across the network (i.e., individual states of the nodes as they change over time). When this trained homeostatic network is embedded in an operating environment with one or more sensors and one or more motors, it will continuously and automatically attempt to re-learn the relationships that minimize accumulated prediction error in a network of similar-acting nodes.

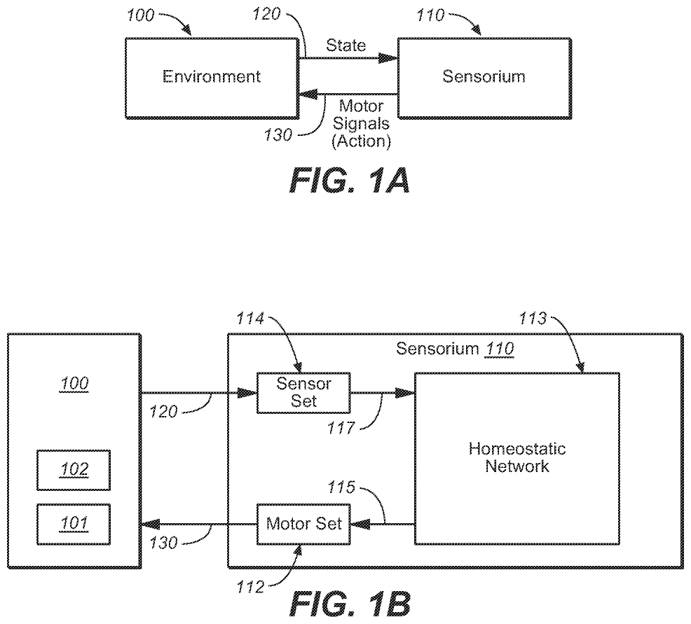

FIG. 1A shows a high-level relationship between an operating environment 100 and a sensorium 110 of the machine-learning control system described herein: Operating environment 100 is informationally coupled to sensorium 110 via (1) one or more environment state information signals 120 flowing from operating environment 100 as inputs to sensorium 110, and (2) a set of motor signals (also referred to herein as “Action”) 130 flowing as outputs from sensorium 110 to operating environment 100.

FIG. 1B shows various components that make up sensorium 110 in one aspect of the machine-learning control system described herein. In this aspect, sensorium 110 includes definitions for a set of at least one motor 112 and a set of at least one sensor 114, including how motor set 112 and sensor set 114 are informationally coupled to a homeostatic network 113 of nodes, via a set of one or more local state information signals 115 and a set of one or more sensor signals 117. In this aspect of the described subject matter, operating environment 100 provides a set of environment state information signals 120 that can be periodically sampled by one or more sensors 114; operating environment 100 in turn samples sensorium 110's motor signals (or “Action”) 130 generated by the one or more motors 112, based upon local state information signals 115 from the homeostatic network 113, in order to update an environmental parameter set 101 of operating environment 100. In this aspect, whenever the environmental parameter set 101 changes (for example, with a time step 130a in a virtual environment, or a sample time 130b at which one or more sensors in the machine-learning control system sample aspects of a physical environment), a set of environment state information signals 120 of operating environment 100 are updated and then sampled by the one or more sensors 114 and presented to sensorium 110; sensorium 110's one or more motors 112 generate a set of one or more motor signals 130, based upon local state information signals 115 of nodes in homoestatic network 113. Motor signals 130, in turn, are sampled by operating environment 100 for reiterative updating of environmental parameter set 101 and the set of environment state information signals 120.

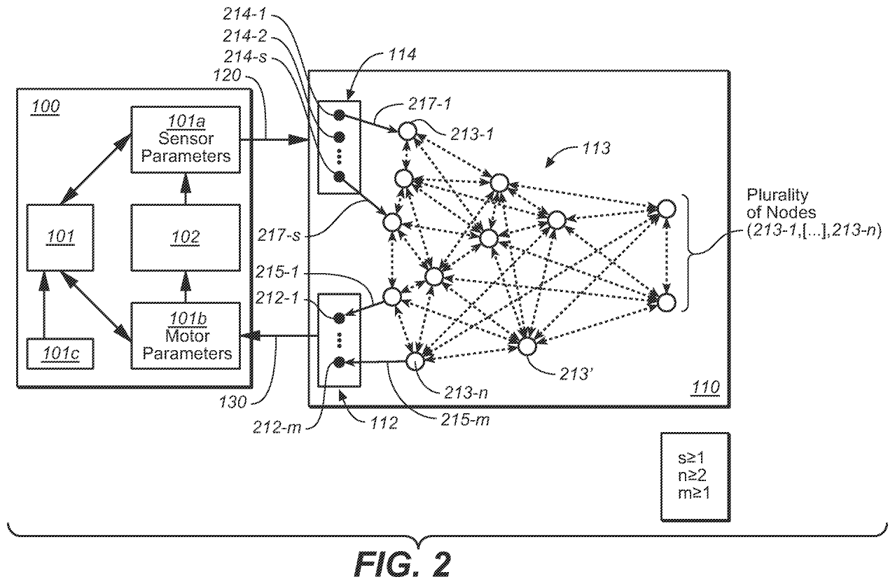

FIG. 2 shows one general aspect of an environmental parameter set 101, which may include, for example, physical motor parameters 101b relating to the generation of external forces by said physical motor, and sensor parameters 101a, e.g. velocity and/or other environment variable(s) directly controlled by the physical motor. Environmental parameter set 101 may also comprise hidden parameters 101c that are not related to any physical sensor input signal nor output motor control signal, such as, for example, size, mass, friction coefficients, or other implicit constraints of the environment such as interconnection between physical components, failure conditions of a task, etc.

In one aspect, and as further described below, sensorium 110 also includes information about relative update frequencies (further described below) between operating environment 100 and homeostatic network 113. In some aspects, sensorium 110 may also include information about defined sensorimotor carrier wave frequencies used in sensor and motor modulation systems, as further described below.

FIG. 2 also shows an exemplary internal structure of sensorium 110, which includes a set of one or more sensors 114. Sensor set 114 periodically samples the set of environment state information signals 120 of operating environment 100 and produces one or more sensor signals 217-1, [ . . . ], 217-s (for s≥1) that are directly informationally coupled to nodes 213-n, [ . . . ], 213-n (for n≥2) (further described below) within homeostatic network 113. A set of one or more motors 112 is also informationally coupled directly to nodes 213-n, [ . . . ], 213-n (for n≥2) (as further described below) within the homeostatic network 113. Motor set 112 generates a set of motor signals 130 that are sampled periodically by operating environment 100, so as to control an element or control behavior 102 within operating environment 100. In one aspect, sensorium 110 also contains a definition of a sensorimotor carrier wave (not shown, but further described below), which may be used for modulating the sensor signals 117 (FIG. 1B) and/or motor signals 130 of sensorium 110, as well as an update rate (not shown) of homeostatic network 113 relative to operating environment 100.

In one general aspect, motor 112 comprises a set of motors 212-1, [ . . . ], 212-m (form ≥1), and sensor 114 comprises a set of sensors 214-1, [ . . . ], 214-s (for s≤1). Motor set 112 and sensor set 114 act as one or more static locations of sensorium 110 which are informationally coupled to an operating environment 100 via motor signals 130 and environment state information signals 120, respectively. In other words, sensorium 110's motors (212-1, [ . . . ], 212-m) and sensors (214-1, [ . . . ], 214-s) comprise nodes of sensorium 110 which maintain fixed (i.e. “static”) interconnection weights between themselves and other nodes 213-1, [ . . . ], 213-n (for n≥2) in homeostatic network 113, thereby providing a boundary for influencing how the machine-learning control system as a whole defines and distinguishes itself from operating environment 100, as part of a generative model of operating environment 100. (In a general aspect, s, n, and m are whole numbers that need not be equal to each other.) In this aspect, sensor set 114 and motor set 112 also have a disproportionate influence on control behavior 102, as they are the sources of data and information that the machine-learning control system uses to derive semantic meaning relevant to control behavior 102 within operating environment 100.

Referring to FIG. 2, sensorium 110 comprises a motor set 112 of at least one motor (212-1, [ . . . ], 212-m), a sensor set 114 of at least one sensor (214-1, [ . . . ], 214-s), and a homeostatic network 113 coupled to motor set 112 and sensor set 114. In this aspect, the homeostatic network 113 itself comprises a plurality of n nodes (213-1, [ . . . ], 213-n), capable of achieving ultrastability within operating environment 100. In this aspect, motor set 112 samples at least one local state information signal 215-m of at least one node in homeostatic network 113, and generates a motor signal 130, based upon the at least one local state information signal 215-m and operable to affect a change in operating environment 100. In this aspect, sensor set 114 periodically samples environment state information signals 120, relating to operating environment 100 and the control behavior 102, and generates at least one sensor signal 217-s, based upon one or more environment state information signals 120 and operable to update one or more nodes from the plurality of n nodes (213-1, [ . . . ], 213-n) in homeostatic network 113, as further described below.

FIG. 2 thus shows an example network layout of one aspect of sensorium 110 and its informational coupling between an operating environment 100, a sensor set 114 of sensors, a motor set 112, and a homeostatic network 113. In one aspect, each node (in the plurality of nodes 213-1, [ . . . ], 213-n) in homeostatic network 113 implements a double-feedback loop that generates ultrastability (as described above). In some aspects, homeostatic network 113 further comprises sparse, rather than dense, interconnections between nodes 213-1, [ . . . ], 213-n.

Referring to FIG. 2, in one aspect, sensorium 110's homeostatic network 113 comprises pre-specified locations for sensor set 114 informational coupling to an initial set of nodes in homeostatic network 113, via (as shown) sensor signals 217-1, [ . . . ], 217-s, and pre-specified locations for motor set 112 informational coupling to an initial set of n nodes in homeostatic network 113, via (as shown) local state information signals 215-1, [ . . . ], 215-m. (Not shown are self-connections at internal nodes.) In this aspect, homeostatic network 113 of the described subject matter has no directional orientation (e.g. front or back, or top or bottom), and is recurrent; signals propagate in various directions continuously.

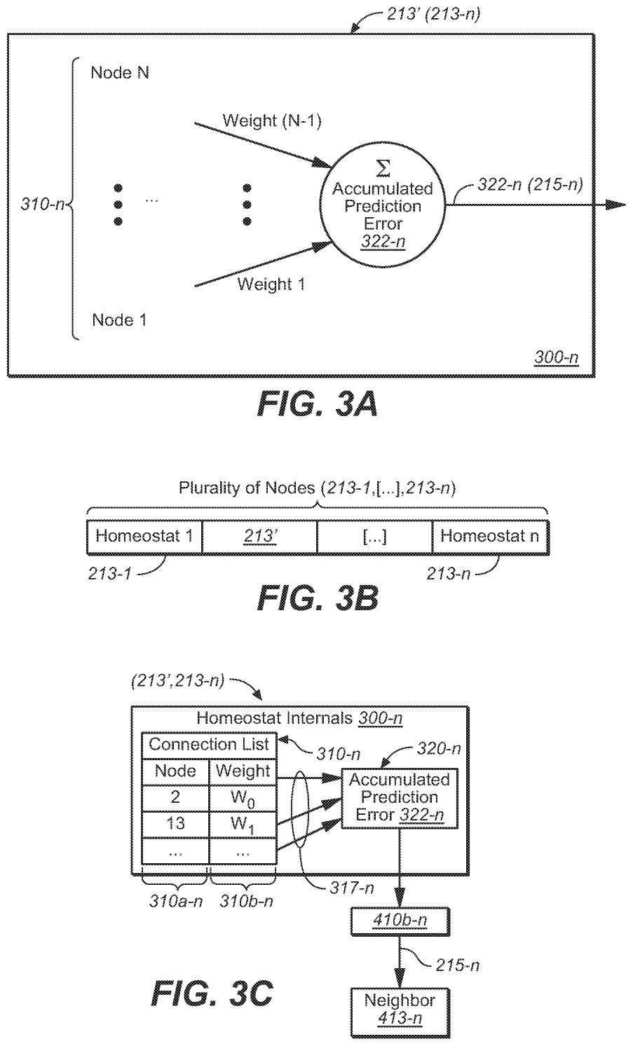

FIG. 3A shows one aspect (and further described below), wherein each node n (homeostat) in homeostatic network 113 implements a chaotic attractor 213′, which is updated as homeostatic network 113 is trained. In one aspect, and as further described below, each chaotic attractor 213′ implements ultrastability as a weighted sum of a set of input connections 310-n into a local state information signal 215-n, which also represents an “accumulated prediction error” 322-n for chaotic attractor 213′ (e.g., 213-n). If the accumulated prediction error 322-n goes beyond a threshold, chaotic attractor 213′ randomly reassigns new weights for its set of input connections 310-n. In this aspect, this process is repeated at each update step of chaotic attractors (i.e., nodes 213-1, [ . . . ], 213-n) in homeostatic network 113.

In this aspect, when an accumulated prediction error 322-n exceeds a pre-defined threshold, new weights (shown in FIG. 3A as Weight 1, [ . . . ], Weight N) are randomly assigned for each incoming connection. Accumulated prediction error can be thought of as a node-local accumulated “surprise.” As further described below, homeostatic network 113 builds a generative model of operating environment 100 that minimizes surprise (accumulated prediction error). In one general aspect, operating environment 100 is first updated, and then sensorium 110 is updated in turn (sequentially: sensors; network; motors). In this manner, interaction between sensorium 110 and operating environment 100 is a continuous process that has been discretized across time and sampled for synchronization between sensorium 110 and operating environment 100.

FIGS. 3B and 3C show exemplary data structures for storing a list of n homeostatic network nodes (homeostats) 213-1, [ . . . ], 213-n, which are allocated storage in contiguous memory in several aspects of the described subject matter. (Non-contiguous configurations may be used, but contiguous memory provides for improved memory caching). FIG. 3B shows a data structure for storing a plurality of n nodes as homeostats in homeostatic network 113. FIG. 3C illustrates how each homeostatic node 213-i (for 1≥i≥n) internally tracks a connection list 310-i corresponding to a local state information signal 215-i of (homeostat) node 213-i.

Thus, as shown by way of example in FIG. 3C, a local implementation for an exemplary chaotic attractor 213′ (homeostat 213-n) of one aspect of homeostatic network 113 of the described subject matter. In this aspect, exemplary chaotic attractor 213′ in the plurality of nodes 213-1, [ . . . ], 213-n is a homeostat comprising a data structure 300-n, which itself comprises a connection list 310-n operable to store a set of connected (neighbor) nodes 310a-n corresponding to a set of connection weights 310b-n, and a memory location 320-n operable to store an accumulated prediction error 322-n. In this aspect, accumulated prediction error 322-n is used by at least one motor 112 of sensorium 110 to determine at a local state information signal 215-n of homeostatic node 213-n.

In this aspect, as shown in FIG. 3C, each homeostatic network node (e.g. 213-n) stores a set of connection weights 310b-n and an accumulated prediction error 322-n, which are updated during learning. During learning, the set of connected (neighbor) nodes 310a-n for a connection stay the same; their corresponding connection weight value is changed when a destabilization occurs. In these aspects, during a node update, connection list 310-n is traversed to calculate a new accumulated prediction error 322-n′ (not shown). In this manner, this aspect of the described subject matter provides a new, efficient manner of implementing a homeostatic network for practical utility in autonomous control engineering and data processing systems.

B. Details On The Learning Process

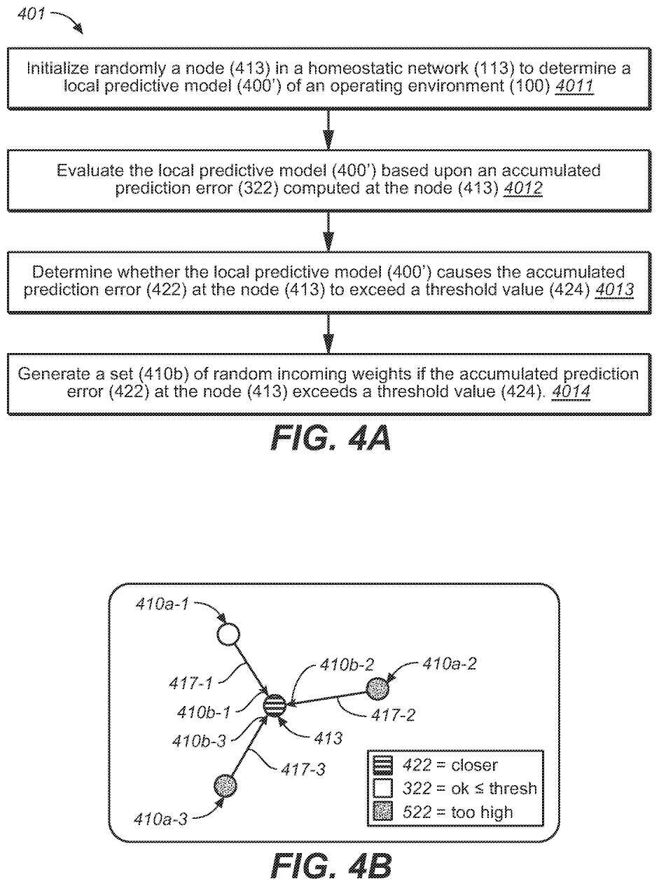

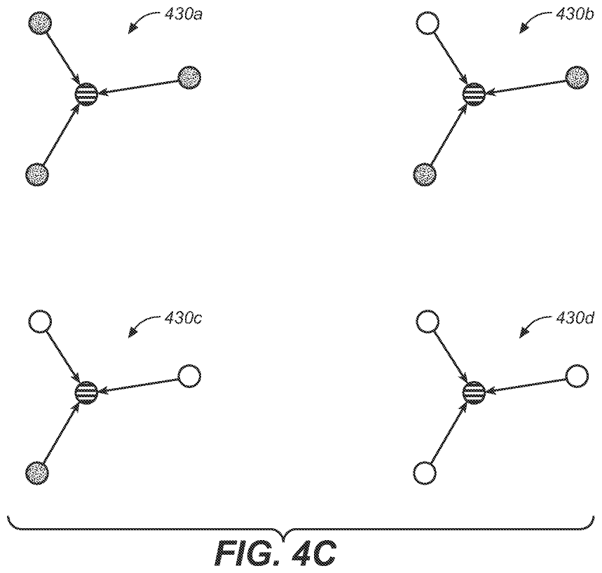

FIGS. 4A, 4B and 4C illustrate generally one aspect of how a homeostatic network 113 of sensorium 110 is able to learn through an active inference process 401. Thus, in one general aspect of the described subject matter, each node 213 in a network 113 is a chaotic attractor (213′) that attempts to predict its environment by building a generative model 400 about sensor signals 117 in the form of randomly-generated (incoming) weights 310b at neighbor node input connections 310a. In this general aspect, this form of prediction builds generative model 400 of the current operating environment 100, rather than an explicit prediction about the next state of operating environment 100. Preferably (though not necessarily), nodes in homeostatic network 113 are performing the same process simultaneously and in parallel.

Referring to FIG. 4A, in some aspects, active inference process 401 may be implemented as follows:
Step 4011: initialize randomly a node 213 in a homeostatic network 113 to determine a local predictive model 400′ of an operating environment 100;
Step 4012: evaluate the local predictive model 400′ based upon an accumulated prediction error 322 computed at node 213;
Step 4013: determine whether the local predictive model 400′ causes the accumulated prediction error 322 at node 213 to exceed a threshold value 424; and
Step 4014: generate a set of random connection weights 410b if the accumulated prediction error 322 at node 213 exceeds threshold value 424.

As an illustrative example involving four interconnected nodes, and referring to FIG. 4B, active inference process 401 may include:
1. At the start of training, node 413 in a homeostatic network 113 is initialized randomly having a connection list 410 of weighted internal connections (410b-1, 410b-2, and 410b-3) from connected (neighbor) nodes 410a-1, 410a-2 and 410a-3, respectively. in the homeostatic network 113; these randomly weighted internal connections represent an initial local predictive model 400′ for node 413 to attempt to self-stabilize.
2. For node 413, whether its local predictive model 400′ is “good” or “bad” is determined by how many update iterations of connection weights 410b-1, 410b-2 and 410b-3 are able to maintain its accumulated prediction error 422 within a threshold value 424. Local state 415 of node 413 is calculated by continuously accumulating weighted incoming signals 417-1, 417-2 and 417-3. These incoming signals could be sensor signals 217-s, but more commonly are connection weights 410b-n for connected (neighbor) nodes 410a-n in homeostatic network 113.
3. When a node 413 destabilizes, it means that its local predictive model 400′ has accumulated too much error (nodes which make poor predictions destabilize first); when this occurs, generate for the destabilized node a new set of random incoming weights (thereby creating a new local predictive model).

Depending upon the level of internal recurrence of signals in the particular homeostatic network chosen for a particular aspect of the described subject matter, as a node 413 resets its connection weights 410b from connected (neighbor) nodes 410a, node 413 redefines its local predictive model 400′. This implicitly alters the global, generative model 400 of environment 100 by changing accumulated prediction error 422. Accumulated prediction error 422 for node 413 is then used to compute a weighted input (local state 415) to its connected (neighbor) nodes.

Conversely, if a given node i has made a “bad” local predictive model but is surrounded by neighbor nodes that have made “good” local predictive models, that given node i's next local predictive model has an increased chance of being “good,” because signals from surrounding nodes have become more predictable. Incoming signals from stable neighbors are more regular than from neighbors that are still searching for good local predictive models. As a result, the chance of guessing a “good” local predictive model is increased by the number of neighbor nodes that already have made “good” local predictive models, in that each of them has achieved a stable state. The result is that parallel exploration of the network's state-space occurs in such a way that network node stabilization propagates via phase transitions into global critical states quickly. While FIG. 4B depicts an example implementation of a network of four nodes and active inference process 401 operating at one of those nodes, active inference process 401, as more generally described herein, may occur at each of n nodes in a homeostatic network 113 having a plurality of n nodes.

FIGS. 4C show a series of diagrams to further illustrate the learning effect in general aspects of the described subject matter. Referring to FIG. 4C, white nodes indicate local predictive models at nodes that have been stable in the recent past; black nodes indicate nodes that have not found stable local predictive models; hatched nodes indicate a node in the process of converging closer to stability (i.e., approaching a threshold value 424). In this general aspect, from the perspective of a single node 413 and at the moment it is generating a new generative model (via generating new incoming signal weights from neighbor nodes), consider the following different local state cases where a node will have increasing probability of finding a new generative model consistent with its neighbor nodes:
State 430a: The neighbor nodes are unstable, and new local predictive models are likely to be of low quality because the incoming signals are chaotic.
State 430b: Eventually some neighbor is able to find a good generative model and stay stable. This increases the likelihood of finding a good generative model, as the incoming signals have become less chaotic.
State 430c: More neighbors become stable. In this case, the likelihood of finding a good generative model is increased further, as incoming signals are constrained to mostly stable signals.
State 430d: Neighbors are stable and providing simple input signals. Finding a stable generative model in this case is usually high probability, because many random weightings can be isomorphic for stable behavior. Being the last node to stabilize within its neighbors implies its semantic influence is lower, and is more likely to destabilize if any of its neighbors also destabilize.

C. Construction of the Homeostatic Active Inference Model

This section provides greater details about the implementation framework of several aspects of the described subject matter as applied to example autonomous control systems and data processing systems which are described herein.

i. Code Base

Preferably (though not necessarily), the code base is split into two pieces:
1. Core Homeostatic Library, written in C++, with Python bindings (intended to be driven from Python), representing a relatively small codebase including functionality for:
   i. Session management (for supporting multiple models at once)
   ii. Sensorium
   iii. Ultrastable Node
   iv. Ultrastable Network structure and topology systems
   v. Sensor Modulators
   vi. Motor Demodulators
   vii. Debugger Support (Historical State Store; Network Topology Query Support)
2. Various Python Test Environments
   i. Running live in the Homeostatic Debugger with various simulated environments
   ii. Doing distributed Monte Carlo runs for learning evaluation (in various simulated environments)
   iii. Simulated Environments to be learned

ii. Data Structure: Sparse, High-Dimensional Cellular Automata

Preferably (though not necessarily), a homeostatic network of the described subject matter is implemented as a sparse, high-dimensional cellular automata (CA), though not all dimensions are necessarily directly represented. The CA is “sparse” because irrelevant dimensions are omitted from the CA representation. Unlike the prior art, instead of being woven into a traditional 2-dimensional matrix of cells (as is customary with cellular automaton simulations), several aspects of the described subject matter instead comprise a network of cells, where each cell has dimensionality equal to the number of incoming connections (which can be different for each cell).

In this aspect, each homeostatic network node is implemented as a cell in a cellular automaton. Several such structures may be implemented by allocating a set of homeostatic nodes a location in contiguous memory (other non-contiguous configurations may be used, but contiguous memory provides for improved memory caching). This memory allocation provides an internal store for a list of connections to other nodes. Using cellular automata in this way, with network-like structure, represents a novel and elegant approach to implementing homeostatic networks over traditional neural networks, providing an efficient way to store and update homeostatic network nodes.

As described above with respect to FIGS. 3B and 3C, exemplary data structures for storing a list of homeostatic network nodes are allocated storage in a contiguous memory in several aspects of the described subject matter. In some aspects, each homeostatic network node stores connection weights and an accumulated prediction error, which are updated during learning. FIG. 3B, for example, shows a list of homeostatic network nodes, 213-1, [ . . . ], 213-n, allocated storage in a contiguous memory in several aspects of the described subject matter. FIG. 3C, for example, illustrates how a node 213-n internally tracks a connection list 310-n. During learning, connected (neighbor) nodes 310a-n for connection list 310-n stay the same; node connection weight values 310b-n are changed when a destabilization occurs. In these aspects, during a node update (further described below), connection list 310-n is traversed to calculate a new accumulated prediction error 322-n′ (not shown), thereby updating accumulated prediction error 322-n at node 213-n. In this manner, this aspect of the described subject matter provides a new, efficient manner of implementing a homeostatic network for practical utility in autonomous control engineering and data processing systems.

iii. System Pseudocode

Aspects of the described subject matter present few constants (e.g., thresholds for the system), because the global behavior of the homeostatic network is such that constants are embedded in learned dynamics.

Pseudocode generally describes system features and methods that may be embodied in a non-transitory computer-readable medium, having stored thereon computer-executable instructions which, when executed by an information processing device, cause the information processing device to execute operations. Below is pseudocode for some aspects of the described subject matter:

InitializeSensorium( )
InitializeEnvironment( )
while True:

# get the state of the motors from the sensorium
motor_signals = Sensorium.get_motor_signals( )
# apply the motor signals to the operating environment
environment_state = Environment.get_state(motor_signals)
# update the sensorium with the new environment state
Sensorium.Update(environment_state)

class Sensorium:

def _{——}init_{——}(self):

“”” sensorium contains:
- List of nodes in its homeostatic network (which internally contain

connection information)

- List of sensors (methods of connecting environment state to a node)
- List of motors (methods of exposing a node's state for driving a motor in

an operating environment)

Motors, sensors and network topology must be supplied for the particular

problem in question “””

self.sensors = Sensors[..]
self.motors = Motors[..]
self.network = UltraStableNodes[..]
# use network topology tools (Layers/Blocks) to connect nodes
self.ConnectNodes( )

def Update(self, environment_state):

# update the sensors-have them sample from operating environment 100

state

self.UpdateSensors(environment_state)
# update the network a number of times specified by the sensorimotor

update rate

for I in range(SENSORIMOTOR_UPDATE_RATE):

UpdateHomeostaticNetwork( )

def UpdateHomeostaticNetwork(self):

for node in self.network:

node.Update( )

def UpdateSensors(self, environment_state):

for sensor is self.sensors:

sensor.sample(environment_state)

def GetMotorSignals(self):

return [motor.GetState( ) for motor in self.motors]

class UltrastableNode:

def_{——}init_{——}(self):

″″″ Each node contains:
- list of incoming connections (weights and a source node)
- accumulated prediction error (a single floating-point value representing
a causal voltage)
States and incoming connection weights are initialized to random values

″″″

self.connections = Connections[..]
self.error = 0

def Update(self):

# perform ultrastability:
# accumulate incoming signals into new state value
for connection in self.connections:

self.error += connection.weight * connection.other_node.error

# if the state value is above a threshold, assign new weightings
if abs(error) > THRESHOLD:

for connection in self.connections:

connection.weight = generate_new_weight( )

In this particular pseudocode aspect, the following may be noted:
Typical THRESHOLD values are between 1 and 100
Sensors normalize their values to [−THRESHOLD, THRESHOLD] when reported to network
Random weights are chosen in the range [−1, 1]
SENSORIMOTOR_UPDATE_RATE is 1 or greater
Instead of having a complex mathematical function that is computing a complex analytical learning model, a network of nodes implemented as chaotic attractors is simulated using relatively simple code.

As one of ordinary skill in the art will appreciate, the adaptive machine-learning model of the subject matter described herein can be implemented using a variety computer programming languages and hardware devices, and with various design options for a variety of engineering applications.

D. Sensorimotor Coupling Involving Modulation/Demodulation Techniques for Homeostatic Networks

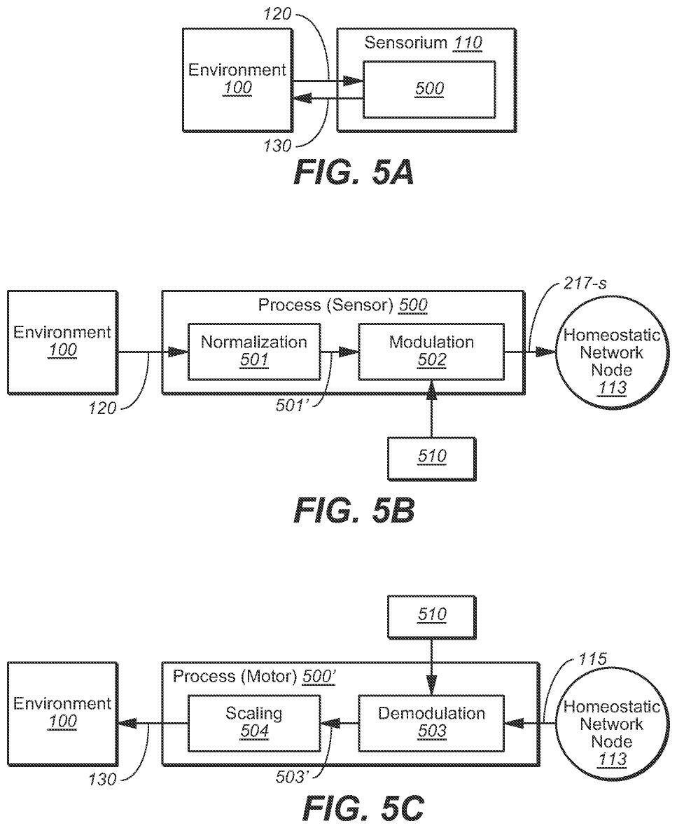

A general aspect of the subject matter disclosed herein includes sensors and motors which, as defined components of sensorium 110, act as an interface between an operating environment 100 and a homeostatic network 113. FIG. 5A further shows one aspect of the machine-learning control system wherein sensorium 110 further includes a process 500 for normalizing and/or modulating signals in sensorium 110.

FIG. 5A illustrates further aspects of process 500, in which sensor set 114 samples a predefined aspect of operating environment 100's set of environment state information signals 120 and normalizes environment state information signals 120 via a normalization process 501 (e.g., to [−THRESHOLD, THRESHOLD] values) followed by a modulation process 502 before presenting sensory signal 217-s to homeostatic network 113. In some aspects, modulation process 502 comprises a sensorimotor carrier wave signal 510, as further described below. In one aspect, as shown in FIG. 5B for example, modulating signals in sensorium 110 comprises using a sensorimotor carrier wave signal 510 operable to generate the least one sensor signal 217-s through a modulation process 502.

Similarly, in some aspects as shown in FIG. 5C for example, motor set 112 samples one or more network nodes 213-n from homeostatic network 113 and, through a process 500′, optionally scales and/or demodulates node local state information signals 115, which is used by motor set 112 to generate motor signals 130 (via, for example, a mathematical formula, a decision algorithm, or a simple on/off switch function) which in turn is then provided to operating environment 100. In this aspect, as shown in FIG. 5C for example, modulating signals in sensorium 110 comprises using a scaling sensorimotor carrier wave signal 510 operable to generate a set of motor signals 130 through a demodulation process 503, creating a demodulated signal 503′, which may then input to a scaling process 504 to generate the motor signals 130.

Thus, as further described in detail below, one aspect of the described subject matter employs modulating sensor signals 117 and motor signals 130 by a sensorimotor carrier wave signal 510. Depending on the behavior desired, such modulation allows for faster learning in many situations.

i. Sensor Modulation Techniques

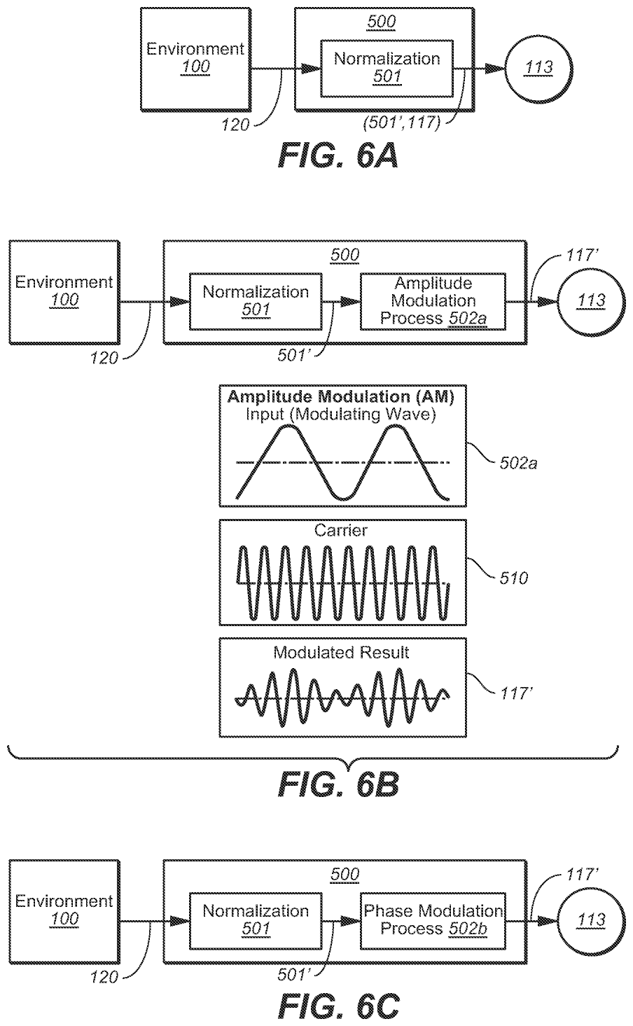

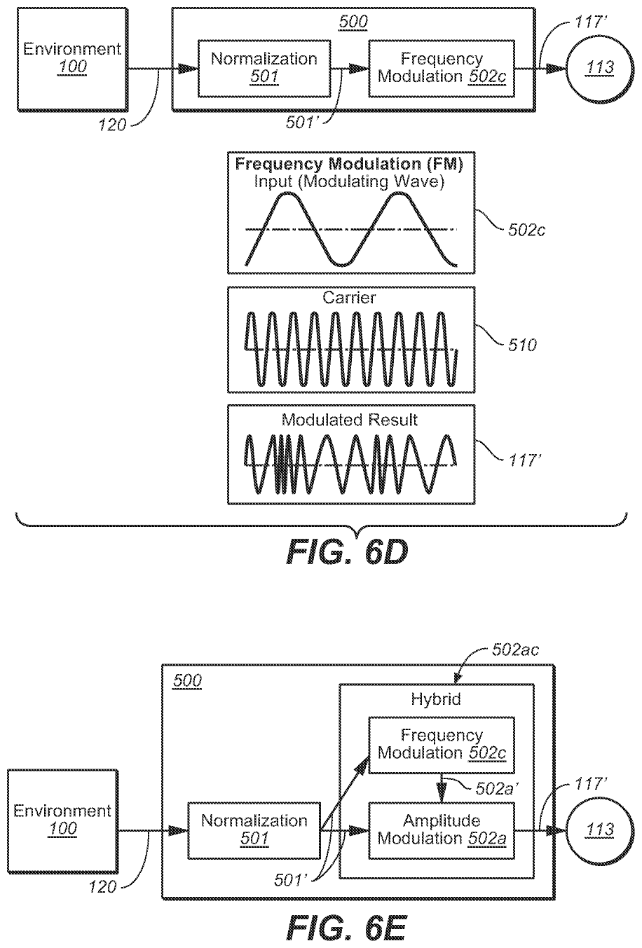

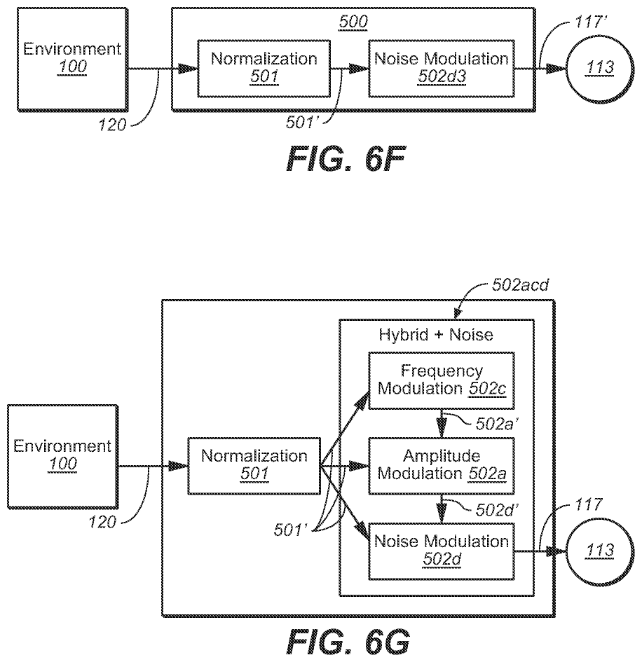

Homeostatic networks of the present aspects are able to learn from unmodulated sensor information; however, in some aspects, several modulation techniques may be employed to improve learning, or otherwise frequency-shift sensorial information in other beneficial ways. For example, FIGS. 6A, 6B, 6C, 6D, 6E, 6F and 6G show several types of sensorimotor coupling of a homeostatic network 113 to an operating environment 100 that may be used in various aspects of the described subject matter.

FIG. 6A depicts direct sensorimotor coupling of a homeostatic network 113 to an operating environment 100, using a process 500 that comprises a normalization process 501 to generate normalized sensor signals 501′ (sent as sensor signals 117 as inputs to homeostatic network 113) relating to environment state information signals 120.

FIG. 6B depicts sensorimotor coupling of a homeostatic network 113 to an operating environment 100, using normalization process 501 to generate normalized sensor signals 501′ relating to environment state information signals 120; normalized sensor signals 501′ are then amplitude-modulated via process 502a, to generate modulated sensor signals 117′. FIG. 6B thus depicts amplitude-modulated sensorimotor coupling, wherein:
a. Normalized sensor signals 501′ are amplitude-modulated with a pre-specified sensorimotor carrier wave signal 510, thereby generating modulated sensor signals 117′; and
b. Frequency-shifted sensor signal data is carried by a high-frequency sensorimotor carrier wave.

FIG. 6C depicts sensorimotor coupling of a homeostatic network 113 to an operating environment 100, using normalization process 501 to generate normalized sensor signals 501′relating to environment state information signals 120; normalized sensor signals 501′ are then phase-modulated via process 502b, to generate modulated sensor signals 117′. FIG. 6C thus depicts phase-modulated sensorimotor coupling, wherein:
a. Normalized sensor signals 501′ are phase-modulated with a pre-specified sensorimotor carrier wave signal 510, thereby generating modulated sensor signals 117′; and
b. Frequency-shifted sensor signal data is carried by a high-frequency sensorimotor carrier wave.

FIG. 6D depicts sensorimotor coupling of a homeostatic network 113 to an operating environment 100, using normalization process 501 to generate normalized sensor signals 501′relating to environment state information signals 120; normalized sensor signals 501′ are then frequency-modulated via process 502c, to generate modulated sensor signals 117′. FIG. 6D thus depicts frequency-modulated sensorimotor coupling, wherein:
a. Normalized sensor signals 501′ are frequency-modulated with a pre-specified sensorimotor carrier wave signal 510, thereby generating modulated sensor signals 117′; and
b. Frequency-shifted sensor signal data is carried by a high-frequency sensorimotor carrier wave.

FIG. 6E depicts sensorimotor coupling of a homeostatic network 113 to an operating environment 100, using normalization process 501 to generate normalized sensor signals 501′relating to environment state information signals 120; normalized sensor signals 501′ are then processed by a hybrid process 502ac, comprising a frequency modulation process 502c, to generate frequency-modulated sensor signals 502a′. Frequency-modulated sensor signals 502a′ are, in turn, amplitude-modulated via process 502a, to generate modulated sensor signals 117′. FIG. 6E thus depicts a hybrid amplitude-modulated and frequency-modulated sensorimotor coupling, wherein:
a. Normalized sensor signals 501′ are first frequency-modulated with a pre-specified sensorimotor carrier wave signal 510, thereby creating a first modulated signal 502a′; and
b. The first modulated signal 502a′ from this frequency modulation is then amplitude-modulated (using the same sensorimotor carrier wave signal 510), thereby generating modulated sensor signals 117′.

FIG. 6F depicts sensorimotor coupling of a homeostatic network 113 to an operating environment 100, using normalization process 501 to generate normalized sensor signals 501′relating to environment state information signals 120; normalized sensor signals 501′ are then processed by a noise modulation process 502d to generate modulated sensor signals 117′. FIG. 6F thus depicts sensorimotor coupling employing normalized sensor signals 501′ plus noise modulation sensorimotor coupling, wherein:
a. Direct coupling of normalized sensor signals 501′ to the homeostatic network, in combination with noise, generates modulated signal signals 117′.

This modulation technique prevents the network from converging on poor behavior, by introducing non-predictable signals when sensors are nearing their effective limits. The technique prevents the homeostatic network from falling into local behavior minima (learning to give up too early).

FIG. 6G depicts sensorimotor coupling of a homeostatic network 113 to an operating environment 100, using normalization process 501 to generate normalized sensor signals 501′relating to environment state information signals 120; normalized sensor signals 501′ are then processed by a hybrid process 502acd, comprising a frequency modulation process 502c, to generate frequency-modulated sensor signals 502a′. Frequency-modulated sensor signals 502a′ are, in turn, amplitude-modulated via amplitude modulation process 502a, to generate amplitude-modulated sensor signals 502d′. Amplitude-modulated sensor signals 502d′ are, in turn, noise-modulated via noise modulation process 50, to generate modulated sensor signals 117′. FIG. 6G thus depicts sensorimotor coupling employing a hybrid amplitude-modulation-plus-frequency-modulation in combination with noise, modulated by the signal value, wherein:
a. Normalized sensor signals 501′ are first frequency-modulated vis sensorimotor carrier wave signal 510, to create a first modulated signal 502a′;
b. The first modulated signal 502a′ is then amplitude-modulated (both using the same sensorimotor carrier wave signal 510), to create a second modulated signal 502d′; and
c. Noise is then combined with the second modulated signal 502d′, thereby generating modulated sensor signals 117′.

ii. Motor Demodulation

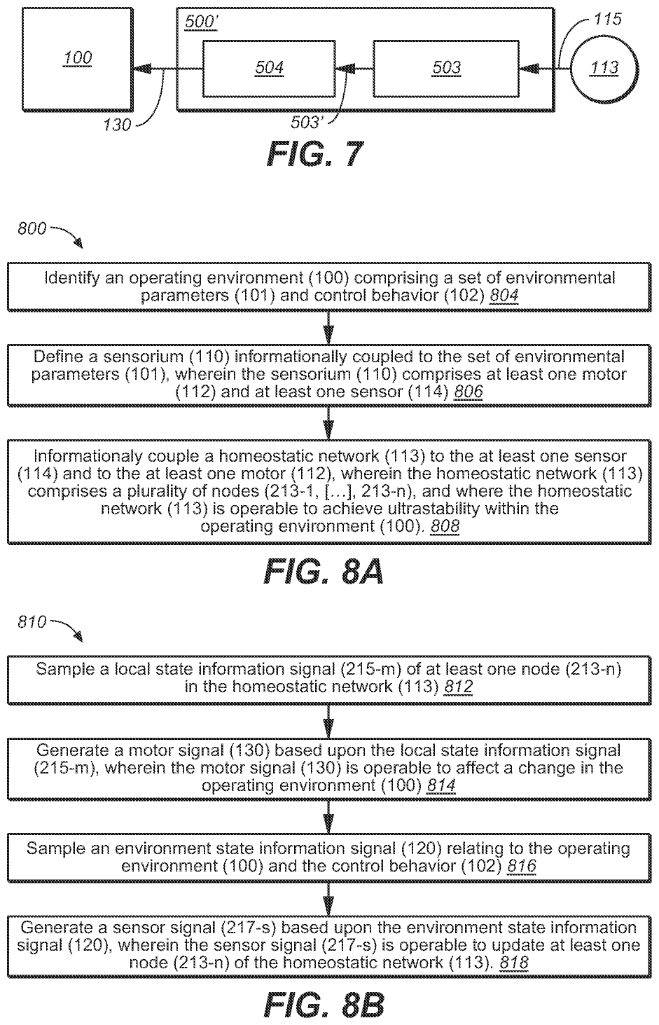

FIG. 7 shows one general aspect for sensorimotor coupling, using a method of motor demodulation to match the method of sensor modulation used to generate modulated sensor signals, thereby allowing to accelerate learning in the homeostatic network 113. Thus, for example, one general motor structure is shown in FIG. 7, in which modulation process 500′ includes a demodulation process 503 and a scaling process 504 for generating the set of one or more motor signals 130 based upon local state information signals 115. Others (not shown) may include amplitude-demodulation, phase-demodulation, and frequency-demodulation processes, which inversely related to modulation process 500 (which may be employed to modulate the sensor signals), as described above and illustrated in FIGS. 6A-6G.

E. Implementation Example of Sensorimotor Coupling: The Cartpole Problem

FIG. 8A is a flowchart depicting one aspect of implementing an algorithm in executable code embodied in a non-transitory computer storage medium which, when executed, performs a method of the subject matter described herein. As shown in FIG. 8A, in one aspect, method 800 for implementing a machine-learning control system in a data processing system comprises: (a) identifying, in the data processing system, an operating environment 100 comprising a set of environmental parameters 101 and a control behavior 102 (step 804); (c) defining, in the data processing system, a sensorium 110 informationally coupled to the operating environment 100, wherein the sensorium 110 comprises at least one motor 112 and at least one sensor 114 (step 806); and (d) coupling, in the data processing system, a homeostatic network 113 to the at least one sensor 114 and to the at least one motor 112, wherein homeostatic network 113 comprises a plurality of nodes (213-1, [ . . . ], 213-n) and where the homeostatic network is operable to achieve ultrastability associated with control behavior 102 within the operating environment 100 (step 808).

FIG. 8B is a flowchart depicting further aspects of an algorithm of executable code embodied in a non-transitory computer storage medium which, when executed, performs a method 810 of training the machine-learning control system of the subject matter described herein. Thus, as shown in FIG. 8B, executable code in the data processing system trains homeostatic network 113 by (a) sampling a local state information signal 215-m from at least one node 213-n in the homeostatic network 113 (step 812); (b) generating at least one motor signal 130 based upon local state information signal 215-m, wherein the at least one motor signal 130 is operable (alone or in conjunction with other motor signals) to affect a change in the operating environment 100 (step 814); sampling at least one environment state information signal 120 relating to operating environment 100 and control behavior 102 (step 816); and generating a sensor signal 217-s based upon the environment state information signal 120, wherein sensor signal 217-s is operable (alone or in conjunction with other sensor signals) to update at least one node 213-n of homeostatic network 113 (step 818).

By way of example, this section provides a reference implementation for a working example of an autonomous stability control system of one aspect of the described subject matter. The problem solved is described in OpenAI's Gym for Deep Reinforcement Learning, Cartpole (https://gym.openai.com/envs/CartPole-v0/). In this problem, the control behavior 102 is to have an agent learn to balance a pole by moving a cart left/right. In this example implementation of one aspect of an autonomous stability control system of the subject matter described herein, a set of four sensors 1614 are defined by the Cartpole problem:
1) angle sensor 1614-1 (of a pole, as difference from vertical);
2) angular velocity sensor 1614-2 (of the pole);
3) position sensor 1614-3 (of a cart, as distance from center); and
4) velocity sensor 1614-4 (of the cart).

In addition, in this example implementation, a single motor 1612-1 generates a set of motor signals 1630 in the Cartpole environment to apply a left/right force 1640 to the cart.

The above sensor and motor definitions comprise the sensorium's informational coupling to the operating environment via sensor parameters 101a (pole angle, pole angular velocity, cart position, cart velocity) and motor parameters 101b (left/right force).

In this example implementation, and referring back to FIGS. 3C and 4B, for any given node n, accumulated prediction error in 322-n at node 213-n is multiplied by a connection weight 410b-n for the given node 213-n, and the result of that multiplication is a value representing local state information 215-n, received by connected (neighbor) node 413-n (which may be a motor 212-m; motor connections, however, are slightly special in that their connection weights are fixed at 1, so the accumulated prediction error 322-n of a connected (neighbor) motor node 212-m is multiplied by a constant value of 1).

Thus, this example implementation illustrates that no explicit reward signal is used by homeostatic network 113 in order to learn how to solve the problem. Instead, a set of sensor signals 117 individually provides implicit goals indirectly, in their definitions as distance from a desired state.

For the cartpole environment, a simulation may provide operating environment 100 for this autonomous stability control problem. One motor applies forces to an object (a cart) in a back-and-forth direction. In this example, velocity (both speed and direction) of the object (cart) comprise environment variables (sensor parameters 101a) directly controlled by the motor. The velocity of the object (cart) also indirectly affects the angle and angular velocity of the pole, which is controlled indirectly through the velocity of the object (cart). Hidden environmental parameters 101c include the size, mass and friction constants of the cart and pole; implicit constraints of the environment (how the cart and pole are connected and failure conditions of the task) also impose hidden environmental parameters 101c. For this reference implementation example, the following sensorimotor carrier wave values may also be used: (i) sensorimotor carrier wave period=30 homeostatic network updates; and (ii) sensorium update rate=360 homeostatic network updates

Thus, if the above-defined cartpole simulator runs at 20 frames-per-second at normal runtime, the internal homeostatic network is updated 360 times between every operating environment update. In other words, in this implementation, sensor and motor modulation/demodulation techniques are set to use a sensorimotor carrier wave equal to a period of 30 internal update time-deltas. This particular configuration updates the internal network at roughly 7200 Hz (20*360), for a simulator updating operating environment at 20 frames/second.

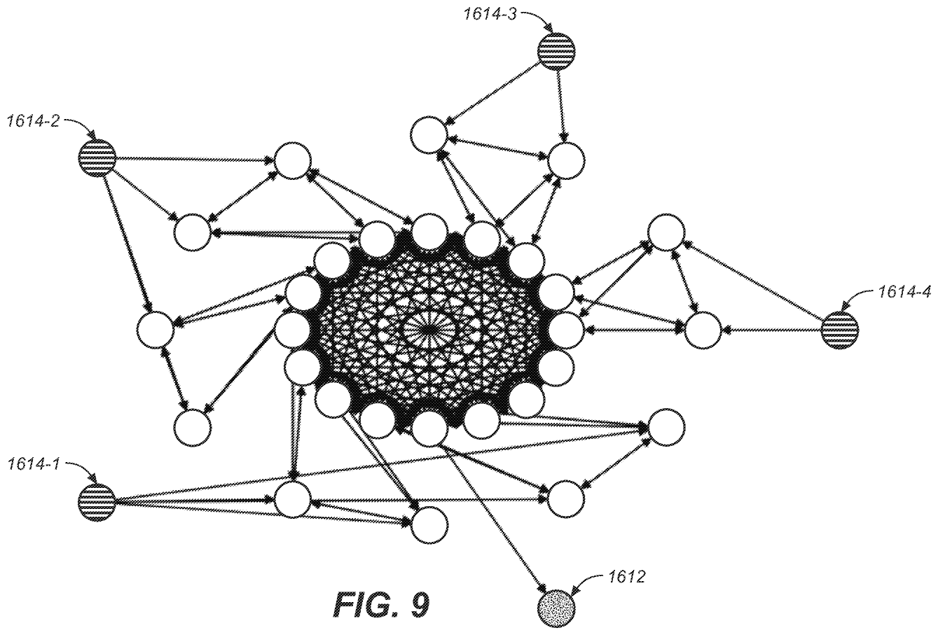

FIG. 9 is a schematic illustration of an example homeostatic network configuration trained to solve the “Cartpole problem” (a stability control problem familiar to those of ordinary skill in the art) as operating environment 100, implementing in one aspect of the subject matter described herein. In this exemplary rendering of a solution, sensors 1614-1, 1614-2, 1614-3 and 1614-4 (white nodes) are informationally coupled to a homeostatic network of nodes (hatched nodes), which in turn are informationally coupled to single motor 1612-1. One of ordinary skill in the art will understand how this basic approach and aspect of the subject matter described herein may be adapted to solve similar mechanical device control problems presenting in various engineering endeavors, such as, for example, in autonomous stable positioning control in various robotics applications, and autonomous control (generally) of mechanical device movement.

F. Method for Automatic Construction of Network Topology

In some aspects (for example, in reference to the Cartpole problem solution, above) a network topology is pre-specified, as shown in FIG. 9. However, more general aspects of the described subject matter may implement a system that automatically generates problem-specific topologies at runtime.

For example, starting with a minimal network, a machine-learning control system of the present subject matter may be constructed that uses feedback from its learning process to automatically “grow” the internal nodes of a network. In this aspect, network nodes are probabilistically chosen for a split, which consists of replacing a single node with a subnetwork of connected nodes.

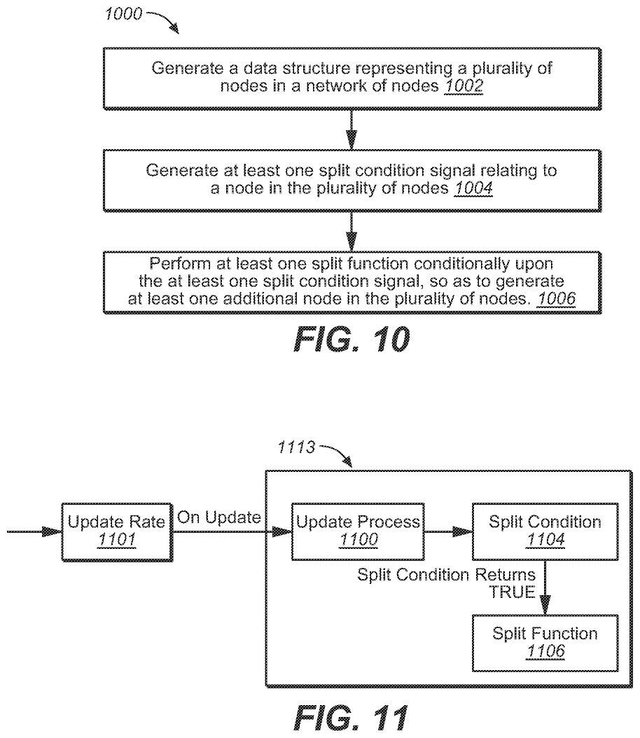

In one aspect, an autonomous control system—comprising a computer processor, a computer-readable hardware storage medium, and program code embodied in the computer-readable hardware storage medium for execution by the computer processor—is configured to implement a machine-learning method 1000, as shown in FIG. 10, comprising:
(1) generating a data structure representing a plurality of nodes in a network of nodes (step 1002);
(2) generating at least one split condition signal relating to a node in the plurality of nodes in the network (step 1004); and
(3) performing at least one split function conditionally upon the at least one split condition signal, so as to generate at least one additional node in the plurality of nodes (step 1006).

In one aspect, method 1000 may be applied to homeostatic network 113; the method may also be applied generally to a plurality of nodes in a network.

FIG. 11 shows how automatic network topology may be achieved using Split Condition process 1104 and Split Function process 1106 upon update process 1100 of a network node 1113 in one aspect of the described subject matter. In such an aspect, the overall system preferably (though not necessarily) comprises at least two components:
1. A Split Condition process 1104, which specifies conditions under which a node 1113 is to be split upon update process 1100; and
2. A Split Function process 1106, which specifies how the network is to be transformed to “split” node 1113 based upon the result of Split Condition process 1104.

Implementation of Split Condition process 1104 and Split Function process 1106 are further illustrated in the following pseudocode for several aspects in which node 1113 is a chaotic attractor 213′ in homeostatic network 113 of the system and method described herein:

def UpdateHomeostaticNetwork( ):

for node in network:

| | |
|---|---|
| node.Update( ) | [update process 1100] |
| if SplitCondition(node): | [split condition process 1104] |

| | |
|---|---|
| SplitFunction(node) | [split function process 1106] |

i. Split Conditions

A Split Condition process 1104 executes a conditional expression (expressed as code) that determines if and when a network node 1113 is to be split. This effectively controls how a network grows, by identifying where the network is to be expanded. There may be many kinds of Split Conditions. For example, in one aspect, split a node has a 1% chance of splitting during every node destabilization. In this example, every time a node destabilizes, it would have a 1% chance of being split (as determined, for example, by a random number generator).

ii. Split Functions

A Split Function process 1106 executes a network-transformation process that is run when the Split Condition process returns TRUE. There are many ways to perform a node “split”, but the end result of a split is a new network topology with improved performance for a control behavior. Splitting a node is effectively taking a single node 1113 in the network and replacing it with more nodes. Here again, there may be many kinds of Split Functions—how the split node's connections are divided amongst the new/replacing nodes can have different properties. For example, in one aspect, when a node is split, a new node is added to the network by connecting to the “splitting” node, and then connecting, in turn, to a randomly-chosen subset of connections from the “splitting” node to other nodes. In this example, implementation of a Split Function randomly connects the new/replacing nodes to other nodes already connected to the splitting node.

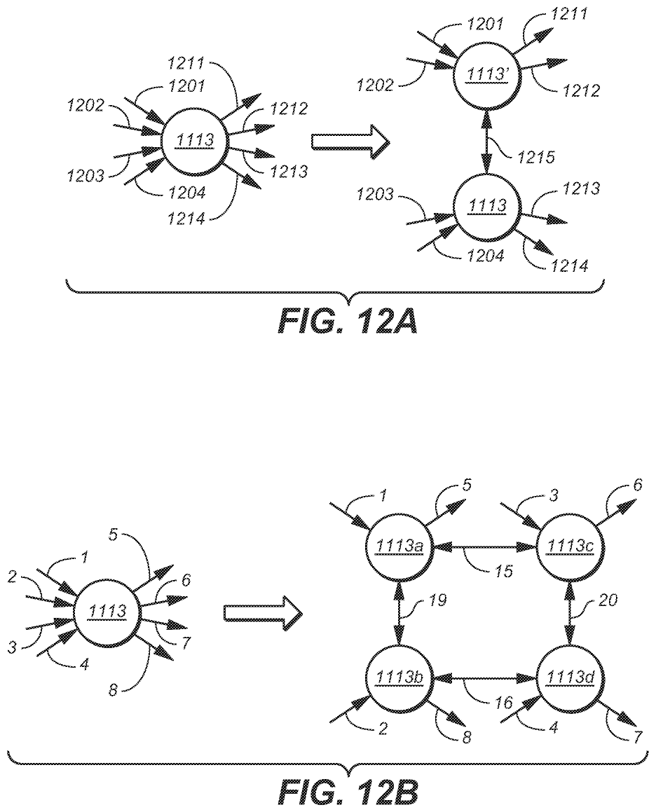

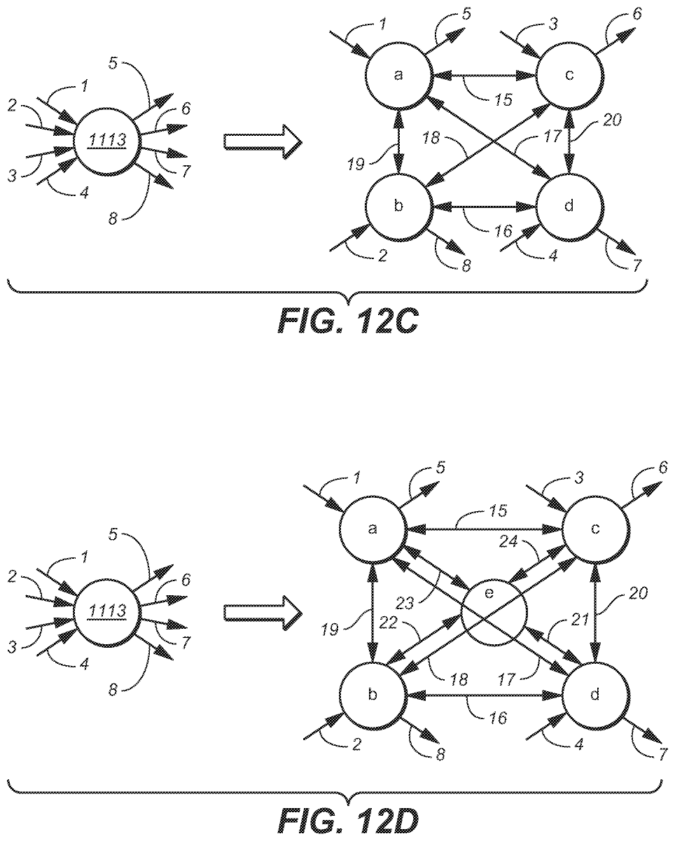

FIGS. 12A, 12B, 12C and 12D show various examples of Split Functions in some aspects of the described subject matter utilizing methods for automatic construction of network topology. For example:
a) Simple Split. In a Simple Split, a node is added and connected to the splitting node. A subset of incoming connections and a set of outgoing connections are moved from the splitting node to the new node. See FIG. 12A (Example of a Simple Node Split Function).
b) Split Into Subnetwork (Decreasing Dimensionality). The goal with this split function is to replace the splitting node with a partially-connected subnetwork, with size equal to the number of incoming connections. The splitting node's external connections are divided amongst this new subnetwork, but the internal subnetwork is not fully connected. This Split Function is considered to “decrease dimensionality,” because each node is of a lower dimensional order than the original node. See FIG. 12B (Example Of A Split Function That Decreases Global Dimensionality).
c) Split Into Subnetwork (Maintaining Dimensionality). The goal with this Split Function is to replace the splitting node with a fully-connected subnetwork, with size equal to the number of incoming connections. The splitting node's external connections are divided amongst this new subnetwork. This Split Function is considered to “maintain dimensionality,” because each node is of the same dimensional order as the original node. See FIG. 12C (Example Of A Split Function That Maintains Global Dimensionality).
d) Split Into Subnetwork (Increasing Dimensionality). The goal with this Split Function is to replace the splitting node with a fully-connected subnetwork, with size equal to more than the number of incoming connections (usually just one). The splitting node's external connections are divided amongst this new subnetwork. This Split Function is considered to “increase dimensionality,” because each node is of equal or higher dimensional order as the original node. See FIG. 12D (Example Of A Split Function That Increases Global Dimensionality).

One of ordinary skill in the art will appreciate that the above-described aspects may be implemented to generate problem-specific network topologies automatically at runtime for machine-learning networks generally, and that such aspects are not limited to the homeostatic network nodes described herein.

G. Implementation Example: Data Compression And Auto-Associative Memory Through Homeostatic Feedback

In some aspects, a homeostatic network may be used as an auto-associative memory in data processing applications. In one such aspect, the systems and methods of the described subject matter may be used, for example, in one or more applications to store and compress data into attractor dynamics.

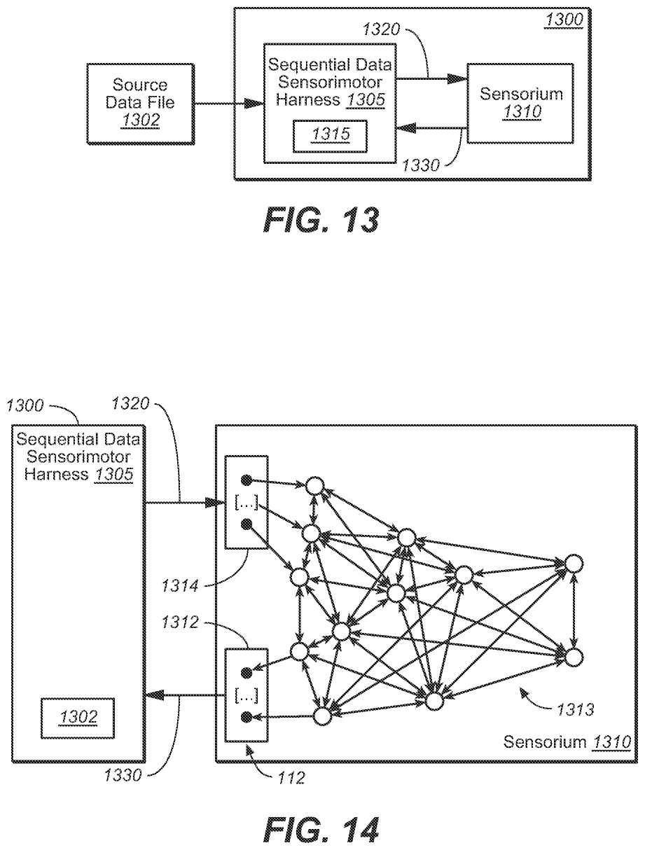

FIG. 13 shows a high-level structure of a data-compression configuration of one aspect of the described subject matter. For example, a data processing system 1300 for data compression is described and intended to work with a source data file 1302 where sequential ordering is relevant. Audio, raw sensory data, video, and images are intended data source types, although others may be used. Higher-dimensional representational (non-causal) data, such as text and language, may also provide appropriate applications.

When applying the homeostatic learning methods of the described subject matter to a source data file, explicit environment or sensorimotor definitions may not be directly identifiable from a given problem to solve; however, the system and method proposed herein provides means to construct special sensors and motors that work together to encode a data-driven signal source into a several aspects to achieve data processing—such as data compression—through homeostatic dynamics as described herein. This is a novel, nonobvious application of using a homeostatic network to compress or otherwise process signal data files.

As a general solution to data processing, and data compression in particular, a description of a general “Sequential Data Sensorimotor Harness” (SDSH) is provided. Referring again to FIG. 1B, sensors 114 and motors 112 in sensorium 110 are interfaces that provide numeral input and output values—sensor signals 117 and motor signals 130—for interpretation by operating environment 100. Referring now to FIG. 13, SDSH 1305 in this aspect is defined by a difference function 1315 that is applied to a set of input (sensor) nodes and a set of output (motor) nodes of the homeostatic network. Thus, the SDSH 1305 provides an operating environment that interprets input and output signals and allows a homeostatic network to learn the signals contained by the data as it is read sequentially.

FIGS. 13 and 14 illustrate the above-described aspect, wherein data processing system 1300 comprises a Sequential Data Sensorimotor Harness (SDSH) 1305 in an application used for data compression applications. In this aspect, and from a high level, there are three parts to this system: (1) a source data file 1302 to be compressed (for example, an audio file); (2) a SDSH 1305 comprising (a) a difference function 1315 that performs a subtraction operation between the data file 1302 and a set of motor signals 1330, (b) a set of motor signals 1330, (c) a set of environment state information signals 1320, and (d) a sensorium 1310 (comprising sensors 1314, motors 1312, and a homeostatic network 1313 to act as a sensor-motor interface); and (3) a homeostatic network 1313. In this aspect, SDSH 1305 subtracts motor signals 1330 from source data signals 1302 to generate environment state information signals 1320 (representing a difference between the source data signals and the motor signals), which are then to the sensorium 1310.

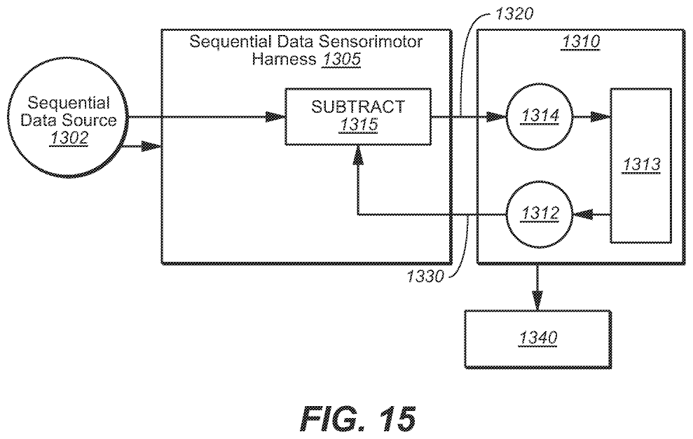

FIG. 15 shows a Sequential Data Sensorimotor Harness of one aspect of the described subject matter, which teaches a network to reproduce a data source. Configured in this way, the homeostatic network will learn to reproduce a source data signal, as the network attempts to learn to predict an incoming sensor signal. Within the SDSH, the incoming sensor signal represents the difference between signals in the motor nodes in the network and raw signal data from the data source. Once the network has achieved a stable state, the state can be saved to a compressed file 1340 in a nonvolatile computer-readable storage medium for later retrieval and use. This file is a simple structure that can be saved using a general data format such as, for example, JSON. This file will contain two sets of data, (1) the network state and weights and (2) a small sample of the original data which is used for decompressing to the original data.

In this aspect, to reconstruct the original data signal, the following steps are performed: (a) initialize the network; and (b) present the saved, original data sample as sensor input to the network. This original data sample reanimates the latent dynamics in the homeostatic network and plays out the stored dynamics within the weights. When the input (sensor) nodes are presented with a sample of the original data (step b above), the homeostatic network nodes will begin to reproduce the original data stream at its output (motor) nodes. The homeostatic network will attempt to continue to reproduce the original data stream, which is transmitted to its output (motor) nodes. As this reads out, the original data signal plays back on the motor nodes in the network (which can be recorded and saved out to a decompressed file).

Methods may also include splitting the source data signal into multiple pieces, to make use of multiple sensors and motors in the homeostatic network. As a result, this system provides a method for compressing general data using homeostatic networks.

Thus, as shown and described herein, applying the machine-learning control system of the described subject matter to other domains, such as file compression, a few changes to the defined framework of several aspects are made. For example, for compressing an audio file containing a song recording, operating environment 100 might simply be a playback of the song recording, with a motor comprising an output speaker, and wherein the homeostatic network aims to generate an audio signal equivalent to the original audio data file. The machine-learning control system's sensors are then defined as a deviation from the audio file signal, as played in a minimal environment, and the audio signals as generated by the network. As the song recording is played and the network updated, the network is presented with the difference between the signal generated by the output speaker (motor) and the next part of the song. Simulating such an operating environment 100 would “teach” the network how to play the audio file (song recording), but with embedding the song recording in the signals and weights of the specific trained network.

Aside from audio files, any data file can be compressed using the same aspect of the described subject matter. For example, any data file can be stored similarly, by expressing the numerical values in the data file in sequential order. In a similar fashion to audio files, this would compress the sequence of data in any input data file.

H. Other Considerations

i. Characteristics of Several Aspects

Some aspects of the described subject matter preferably (though not necessarily) exhibit and/or include the following features and characteristics:
Ultrastability is fully functional in each chaotic attractor in the network.
The network is updated synchronously and in short time steps, in order to simulate a functional implementation of a machine-learning control system using a simple interface and framework, thereby facilitating a wide variety of applications in a continuous (over time) environment.
Sensor and motor definitions are semantically-rich and relevant for the desired (control) behavior
The network topology's size and connectivity is chosen large enough to solve the defined problem (i.e. to reach a desired (control) behavior within a desired timeframe)
The network topology complexity is low enough to converge quickly (in relevant timescales) to achieve critical state. (Without critical state, behavior of the system is undefined and/or chaotic.)

ii. Homeostatic Network Debugger

A debugger apparatus for viewing runtime behavior of various aspects of the machine-learning control system of the described subject matter is also provided herein. Such homeostatic network debugger apparatus allows to view runtime behavior at various timescales, in both time-based phase portraits and frequency-based phase portraits. A homeostatic network debugger apparatus displays individual attractor behavior in either time-domain historical phase portraits or frequency-domain (windowed) phase portraits. A homeostatic network debugging feature allows scaling of the learning environment over five orders of magnitude of time scales.

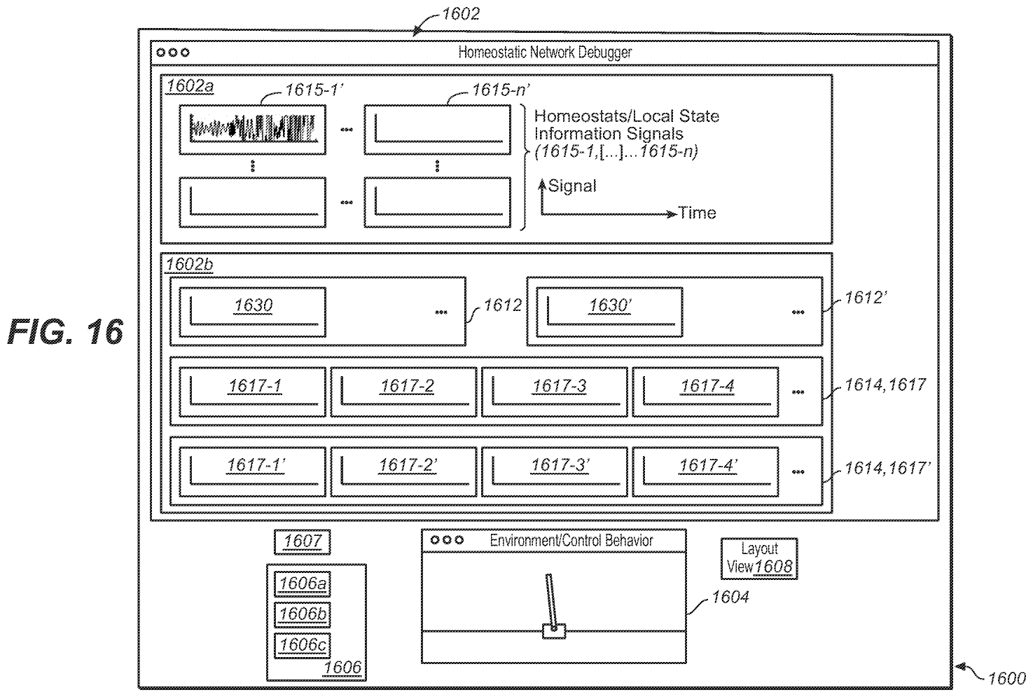

FIG. 16 shows one aspect of the user interface of a homeostatic debugger apparatus for the described subject matter. In particular, in order to debug and work with homeostatic networks of the described subject matter, a homeostatic network debugging feature for visualizing network behavior is provided.

As shown in FIG. 16, a homeostatic debugger environment 1600 is preferably (though not necessarily) made up of two processes running in separate display windows of a graphical user interface: (1) a main debugger window 1602, which dynamically displays network node dynamics for sensorium 110 at runtime (and may be further partitioned into separate displays for sensors/motors (1602b) and homeostatic network nodes (1602a)); and (2) an environment display window 1604 allowing visualization of operating environment 100 being learned.

In order to capture fine-scale dynamics of each homeostatic node at runtime (as well as sensors and motors) in a way that they are time-correlated, the state of sensorium 110 (e.g., network, sensors and motors—see FIG. 2) is saved in a nonvolatile computer-readable storage medium in a at each update step (for example, at 7200 Hz in the Cartpole example described above).

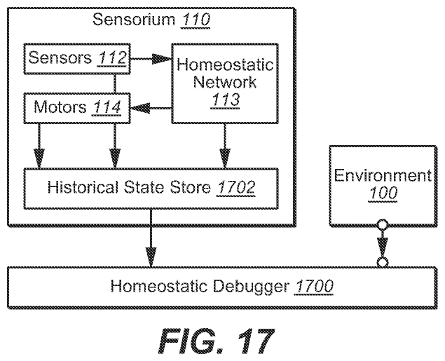

FIG. 17 shows dataflow for one aspect of a homeostatic debugger 1700 for the described subject matter. As shown in FIG. 17, this state is preferably (though not necessarily) stored in a historical state store 1702 as an additional component of sensorium 110, for eventual querying by homeostatic debugger 1700. Homeostatic debugger 1700 periodically (for example, at ˜20 Hz), pulls historical state store 1702 into the homeostatic debugger environment 1600 (see FIG. 16) for visualization on a display (not shown). The debugger also periodically (for example, at ˜20 Hz) updates visual representation in environment window 1604 (see FIG. 16) of operating environment 100 to visualize actual behavior in operating environment 100.

Referring back to FIG. 16, in some aspects of a homeostatic debugger environment 1600, features may include:
1) Homeostat Display (1602a). In one aspect, each homeostatic network node is rendered in the homeostatic network debugger as a 1-dimensional phase-space portrait (“graph”) over time (1615-1, [ . . . ], 1615-n). The graph updates as the simulation and network is advanced in time. Preferably (though not necessarily), this feature can display any number of homeostatic network nodes, at for example, 30 per page. Preferably (though not necessarily), this feature can also display phase-space portraits in both time- and frequency-domain. This feature also preferably (though not necessarily) supports toggling of auto-scaling of the graph, for viewing THRESHOLD-normalized graphs or for dynamically adjusting graph axes to maximize visibility of network dynamics. See e.g FIG. 16.
2) Sensor and Motor Display (1602b). In one aspect, as shown, sensor set 1614 and motor set 1612 in sensorium 110 are graphed as both raw, unmodulated sensor signals 1617 (e.g., as shown, 1617-1, 1617-2, 1617-3 and 1617-4) and, if applicable, a set of modulated sensor signals 1617′ (e.g., as shown, 1617-1′, 1617-2′, 1617-3′ and 1617-4′) presented to the homeostatic network.
3) Simulation Time Controls (1606). In one aspect. this feature preferably (though not necessarily) comprises at least the following processes: (a) Pause/Unpause simulation process 1606a; (b) Adjust simulation speed process 1606b (e.g., from 0 Hz to 4,000,000 Hz, depending on computer speed); and (c) tuning process 1606c, for tuning historical graphs to different timescales.
4) Network Weight Export Process (1607). In one aspect, this feature is a debugger command that allows exporting of the network weights to the graphical user interface, for easy inspection for problems.
5) Environment Display Window (1604). This feature shows the effective runtime control behavior of operating environment 100 as controlled by sensorium 110.

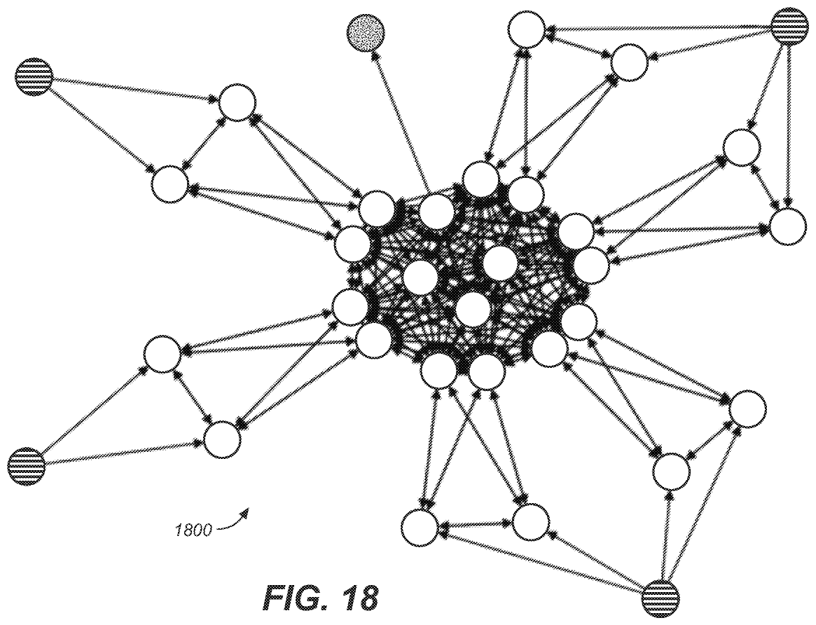

In addition to the above homeostatic debugger features, a Network Layout Render View process 1608 may also be implemented. FIG. 18 shows one aspect of a network layout render view 1800 for the described subject matter (another example is shown in FIG. 9 for one solution for the cartpole problem) This feature allows for quick visualization of the network topology inside sensorium 110. Preferably (though not necessarily), a network layout render for a homeostatic network 113 in a given sensorium 110 can be saved in a nonvolatile computer-readable storage medium, and retrieved for future reference or use. Nodes may be color-coded (not shown) to highlight sensors, motors, stable nodes, unstable nodes, etc. (here shown as different hatch patterns).

I. Advantages of Several Aspects of the Machine-Learning Control System

The aspects described herein present numerous advantages over prior machine-learning control systems. Included among those advantages are, in particular:
Less Data Required. Compared with Deep Reinforcement Learning systems of the prior art, the described subject matter provides a system and method of learning which requires much less data—some aspects of the described subject matter show a reduction of 2-3 orders of magnitude less data to learn equivalent behaviors.
Less Computational Hardware Required. Compared with Deep Reinforcement Learning systems of the prior art, the described subject matter provides a system and method of learning which requires much less computational hardware—some aspects of the described subject matter utilize roughly 4-5 orders of magnitude less memory and computation resources needed to achieve similar behavior.
No Explicit Reward Function Means Greater Simplicity. Deep Reinforcement Learning systems of the prior art require an external Reward function to be designed, in order to guide the progress of learning. Several aspects of the described subject matter, however, do not require an explicit Reward function; instead, the rewards are implicitly supplied through one or more sensor definitions, which are simpler to implement and combine than traditional Reward functions.
Improved Scalability. Several aspects of the described subject matter provides improved scaling efficiency in higher-dimensional models than traditional machine learning models.

J. Software Implementation of a Functional Homeostatic Network for Real-Time Active Inference

The described subject matter comprises novel implementations of networks comprising a plurality of homeostatic nodes. Such networks, as implemented herein, are capable of achieving ultrastability, thereby providing a new and useful paradigm for machine-learning control systems that use various combinations of positive and negative feedback loops, which generate negative entropy in a homeostatic network and allow the networks to self-organize into near-equilibrium critical states.

Aspects of the subject matter described herein achieve ultrastability using processes performed in groups of homeostatic network nodes, interconnected in one or more networks, thereby generating a form of group homeostasis.

Ultrastability, implemented via the method described herein as one aspect of the described subject matter, uses relationships between sensorial-based signals and weights in the network, wherein those relationships are preferably (though not necessarily) near circular-causal: i.e., signals passing through the network from sensors to motors are modified by weight values as they propagate, but the weight values themselves are modified by the signal values as they pass through an ultrastable node. In such aspects, the homeostatic network reaches equilibrium (or becomes coherent) when the circular-causal relationship between signals and weights are self-generative, self-stabilizing, self-propagating, self-repairing, and/or self-persistent.

The aspects described herein also demonstrate how the property of ultrastability can be used when informationally coupling a homeostatic network to an operating environment, in order to generate useful control behavior in the informationally coupled environment. Put another way, the aspects provide an active inference process 401 for achieving homeostatic equilibrium extending from a set of motors 112, through an operating environment 100 and back into a homeostatic network 113 through a set of sensors 114, in an effective and elegant method that allows adaptation to environment-specific interactions. Aspects of the active inference process 401, as described herein, are therefore ideal for implementation in autonomous control systems for various commercial and industrial control and decision processes, such as, for example, logistics, robotics, natural language processing, and computer vision; it can also be adapted for other related processes, such as data compression systems, anomaly detection, and a variety of prediction systems, such as, for example, self-driving cars. The various applications of the described subject matter are innumerable.

In one general aspect of the described subject matter, the machine-learning control system learns one or more control behaviors by using a circular-causal relationship between sensorial-based signals and weights in the network, to build a generative model of environmentally-sensed relationships.

In one aspect, functional implementation of a homeostatic network node is written in C++ and Python, and included in computer software in a manner that allows for the creation of large, functional homeostatic networks; however, one of ordinary skill in the art will recognize that other computer programming languages and design options may be used (See further details below on High-Level Functional Software Design). This aspect thus provides a working software implementation that produces ultrastability and homeostasis in a system, in such a way that can be generally adapted to many sets or combinations of sensor and motor definitions—for example, whether the sensors and/or motors are embedded in a virtual environment, or whether actual physical sensors and physical motors are employed—for a variety of real-world applications.

As described herein, aspects of the described subject matter are able to reliably reach and maintain a near-equilibrium critical state through ultrastability. (See further details below on the Ultrastable Node). Combinations of software, hardware, firmware and the like may also be used to accomplish functionally equivalent aspects of the described subject matter.

In addition, through the use of novel sensorimotor modulation techniques, as described herein, aspects of the described subject matter are able to solve several mechanical control problems with orders of magnitude less computational time and memory than previously known Deep Reinforcement Learning techniques. (See further details below on Sensorimotor Modulation Techniques.)

Aspects of the described subject matter also include novel software development tools for constructing homeostatic networks, as described above regarding, for example, the structural design of a homeostatic debugger (and as illustrated by examples shown in FIGS. 16, 17 and 19). Further details describing additional software development tools are described below (see Network Construction Toolkit).

i. Construction of the Ultrastable Node

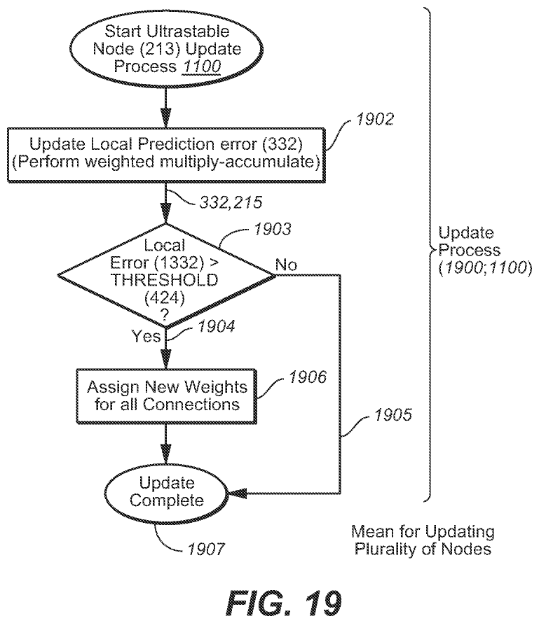

FIG. 19 shows, for example, a flowchart of one aspect of the described subject matter. Referring to FIG. 19, the flowchart illustrates a generate update process 1100 that is performed by an ultrastable node 213 when sensorium 110 is updated. In this aspect (and as briefly described above with respect to FIGS. 3A, 3B and 3C), each chaotic attractor 213′ implements ultrastability as a weighted sum of input connections (step 1902) into a local state information signal 215, which represents an accumulated prediction error 322 for chaotic attractor 213′. Stability of node 213′ is determined by whether or not accumulated prediction error 322 exceeds a threshold value 424 (step 1903): If accumulated prediction error 322 goes beyond a threshold value 424 (signal 1904), then chaotic attractor 213′ randomly reassigns new weights 310b for its input connections 310a (step 1906) before the update process is completed (at step 1907); if, however, prediction error 322 is less than or equal to threshold value 424, then update process 1100 for chaotic attractor 213′ is completed (at step 1907), with no new weight assignments made. In this aspect, this process is repeated at each update step of the chaotic attractors (the plurality of nodes 213-1, [ . . . ], 213-n) in the homeostatic network. Software implementation of this flowchart may be written in, for example, C++, with each ultrastable node preferably (though not necessarily) allocated as an array in computer memory, contained within in a Sensorium Class. (One of ordinary skill in the art will recognize that other computer programming languages and design options may be used.)

In such an aspect, each node operates independently, taking input from each of its input connections, performing chaotic attractor dynamics, and computing a local “error” value, which is then used as input(s) to the other nodes in the network as they perform the same process. By way of further illustration, the basic pseudocode (in Python) for this particular aspect is shown below:

class UltrastableNode:

def_{——}init_{——}(self):

“““ Each node contains:
- list of incoming connections (weights and a source node)
- accumulated prediction error (a single floating-point value representing
a causal voltage)
States and incoming connection weights are initialized to random values

”””

self.connections = Connections[..]
self.error = 0

def Update(self):

# perform ultrastability:
# accumulate incoming signals into new state value
for connection in self.connections:

self.error += connection.weight * connection.other node.error

# if the state value is above a threshold, assign new weightings
if abs(error) > THRESHOLD:

for connection in self.connections:

connection.weight = generate_new_weight( )

The accumulated error prediction function is depicted in FIG. 3A and described above. The update( ) function of this example implements the property of ultrastability. When connected to other ultrastable nodes, this property is used to generate homeostatic equilibrium across nodes in the homeostatic network.

The “error” value in the above-listed pseudocode is also an output value for the node—which is a signal representing the accumulation of error over time. By using ultrastability to confine a node's prediction error within a threshold value (over time), long-term stable homeostatic equilibrium is achieved. Thus, one general aspect of the described subject matter is to implement ultrastability, which is able to confine prediction error over time by successive self-redefinition until a stable configuration is found.

ii. High-Level Functional Software Design

There are many ways to connect a homeostatic network to an operating environment 100. One general aspect is depicted in FIGS. 1A and FIG. 1B, as mentioned above, wherein operating environment 100 provides environment state information signals 120, which can be sampled via a set of sensors 114 by sensorium 110. Sampling in this context implies taking some measurable quantity from operating environment 100 and translating it into a continuous numerical value.

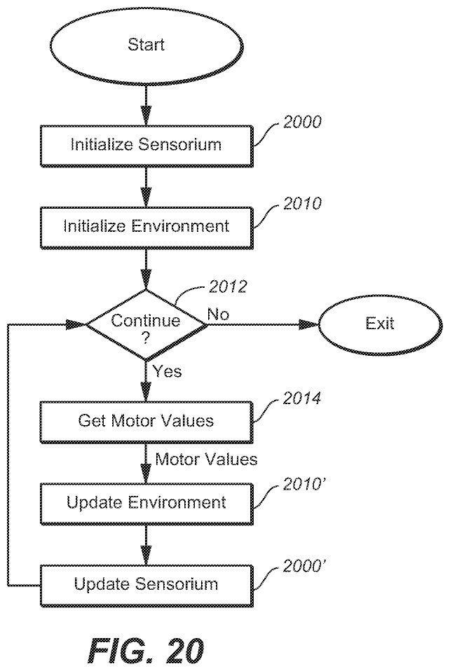

FIG. 20 shows a flowchart of the general structure of one aspect of the described subject matter. Example software pseudocode (in Python) for this aspect is shown below:

| InitializeSensorium( ) | | (step 2000) |
|---|---|---|
| InitializeEnvironment( ) | | (step 2010) |
| while True: | | (step 2012) |
| | # get the state of the motors from the sensorium | |
| | motor_signals = sensorium.get_motor_signals( ) | (step 2014) |
| | # apply the motor signals to the operating environment | |
| | environment_state = Environment.get_state(motor_signals) | (step 2010’) |
| | # update the sensorium with the new environment state | |
| | sensorium.Update(environment_state) | (step 2000’) |

In this aspect, sensorium 110 comprises one or more motors 112, which provide motor signal 130 comprising continuous values in response, where those values are translated into some motor function in operating environment 100. The software for this aspect is written in a general way, such that it can be applied to any sensorimotor definition that uses continuous numerical values, such as voltages, which get translated into digitally-represented numerical values when processed by the homeostatic network. This aspect of the described subject matter is therefore highly adaptable to solving a variety of real-world control problems, as mentioned above.

Referring back to the schematic diagram of FIG. 2 shows how the set of environment state information signals 120 flows through one or more sensors of sensorium 110, and is presented to the homeostatic network of sensorium 110 preferably (though not necessarily) as a set of continuous numerical values representing sensor signals 217-1, [ . . . ], 217-s. In one general aspect, the homeostatic network also provides a stream of continuous numerical values through motor definitions, which can modify (affect a change in) environment state. In this general aspect, the manner in which sensors and motors are informationally coupled to a particular environment is generic and flexible and intended to serve a wide variety of purposes.

Regarding a software implementation of one aspect, sensorium 110 may be implemented as a class containing the definition of sensors, motors, and homeostatic nodes that define an agent and how it interacts with an operating environment 100. In this implementation, sensorium 110 comprises data structures for storing: (1) a list of sensors; (2) a list of motors; and (3) a list of ultrastable nodes. In this implementation, each ultrastable node comprises, in turn: (1) current “state” (accumulated prediction error); and (2) list of connections to other ultrastable nodes. Exemplary pseudocode (in Python) for this implementation is shown below:

class Sensorium:

def_{——}init_{——}(self):

“”” sensorium contains:
- List of nodes in its homeostatic network (which internally contain

connection information)

- List of sensors (methods of connecting environment state to a node)
- List of motors (methods of exposing a node's state for driving a motor in

an operating environment)

Motors, sensors and network topology must be supplied for the particular

problem in question “””

self.sensors = Sensors[..]
self.motors = Motors[..]
self.network = UltraStableNodes[..]
# use network topology tools (Layers/Blocks) to connect nodes
self.ConnectNodes( )

def Update(self, environment_state):

# update the sensors-have them sample from the operating environment

state

self.UpdateSensors(environment_state)
# update the network a number of times specified by the sensorimotor

update rate

for I in range(SENSORIMOTOR_UPDATE_RATE):

UpdateHomeostaticNetwork( )

def UpdateHomeostaticNetwork(self):

for node in self.network:

node.Update( )

def UpdateSensors(self, environment_state):

for sensor is self.sensors:

sensor.sample(environment_state)

def GetMotorSignals(self):

return [motor.GetState( ) for motor in self.motors]

class UltrastableNode:

def_{——}init_{——}(self):

″″″ Each node contains:
- list of incoming connections (weights and a source node)
- accumulated prediction error (a single floating-point value representing
a causal voltage)
States and incoming connection weights are initialized to random values

″″″

self.connections = Connections[..]
self.error = 0

def Update(self):

# perform ultrastability:
# accumulate incoming signals into new state value
for connection in self.connections:

self.error += connection.weight * connection.other_node.error

# if the state value is above a threshold, assign new weightings
if abs(error) > THRESHOLD:

for connection in self.connections:

connection.weight = generate_new_weight( )

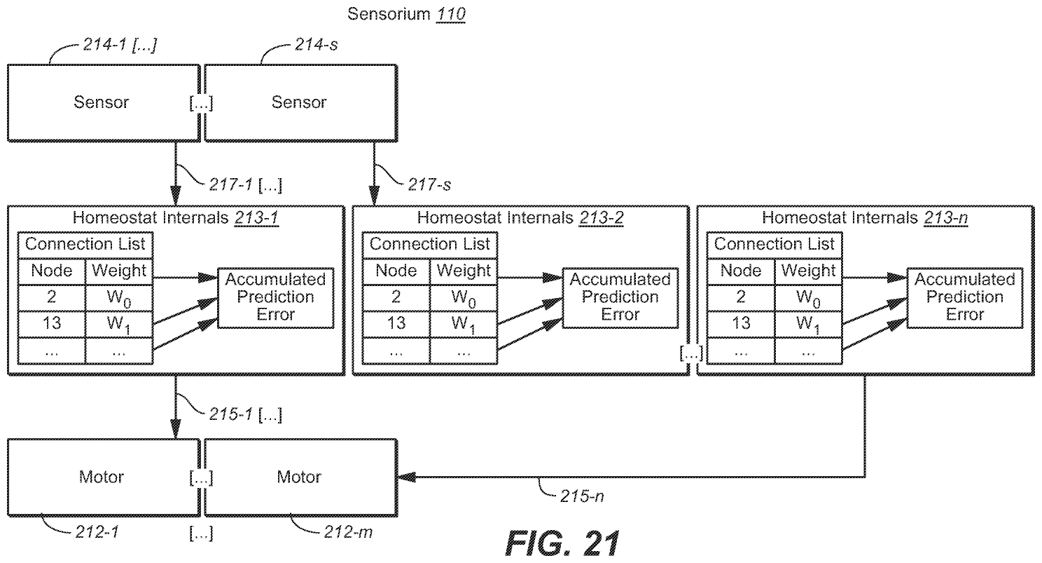

FIG. 21 shows further details of sensorium 110 in some aspects of the described subject matter is implemented, consolidating various aspects of data structures and informational coupling between sensorium components depicted in FIGS. 2, 3A and 3C.

In the above aspect of the described subject matter, in order to perform useful work (i.e., useful behavior from sensorium 110), a simulation environment (or in real-time, if using physical sensors and motors) is advanced alongside sensorium 110 in a circular fashion. With each cycle in virtual environments, the simulation advances in time; in physical environments, the passage of time triggers periodic updates of sensorium 110.

For example, in one application of the above aspect, a robotic system with some sensors or motors can be set to update 10 times per second. This means that every 100ms, the sensors are sampled, the homeostatic network updated, and the output motor values updated. From the perspective of the homeostatic network, its function is preserved whether operating environment 100 is physical or virtual. (See above description, “Construction Of The Homeostatic Active Inference Model.”)

iii. Network Construction Toolkit

One aspect includes a set of tools for manual construction of network topologies. This aspect is an additional feature supporting automatically generating network topologies, as described above.

In one general aspect of the described subject matter, subnetwork constructions are created and assembled in sensorium 110 to create larger networks of nodes, sensors and motors that are able to perform useful behavior. There are a number of ways network topologies can be specified and created.

In one aspect, two main basic primitives for network topology construction is used: (1) Layers, and (2) Blocks. Layers are a cluster of connected nodes; Blocks are sets of Layers connected together in a stacked arrangement.

1) Node Allocator

To ease the development of various network topology construction methods, a novel Node Allocator system is used in various aspects to request new, unused, and unconnected nodes to be added to the network and connected in meaningful ways. This Node Allocator system is an elegant software tool that separates instantiation of homeostatic network nodes in computer memory from their use (i.e. allocation) in a homeostatic network. The Node Allocator provides an easy method for requesting unused homeostatic network nodes from a large pool of globally allocated nodes. Basic pseudocode (in Python) for a Node Allocator of one aspect of the described subject matter is set forth below:

class NodeAllocator:

def_{——}init_{——}(self, size):

self.unllocated_nodes = UltrastableNodes[..]

self.allocated_nodes = [ ]

def AllocateNode(self):

node = self.unllocated_nodes.pop( )

self.allocated_nodes.append(node)
return node

2) Node Layer

In one aspect, a Node Layer software class is a simple network primitive that constructs a small subnetwork of nodes that are all connected to each other (also referred to as “fully-connected”). Basic pseudocode (in Python) for a Node Layer of one aspect of the described subject matter is set forth below:

class Layer:

def_{——}init_{——}(self, size, node_allocator):

self.nodes = UltrastableNodes[..] from node_allocator

self.size = size
# connect all the nodes to each other
for node in self.nodes:

for other_node in self.nodes:

other_node−>Connect(node)
node−>Connect(other_node)

def GetSize(self):

return self.size

def GetNode(self, index):

return self.nodes[index]

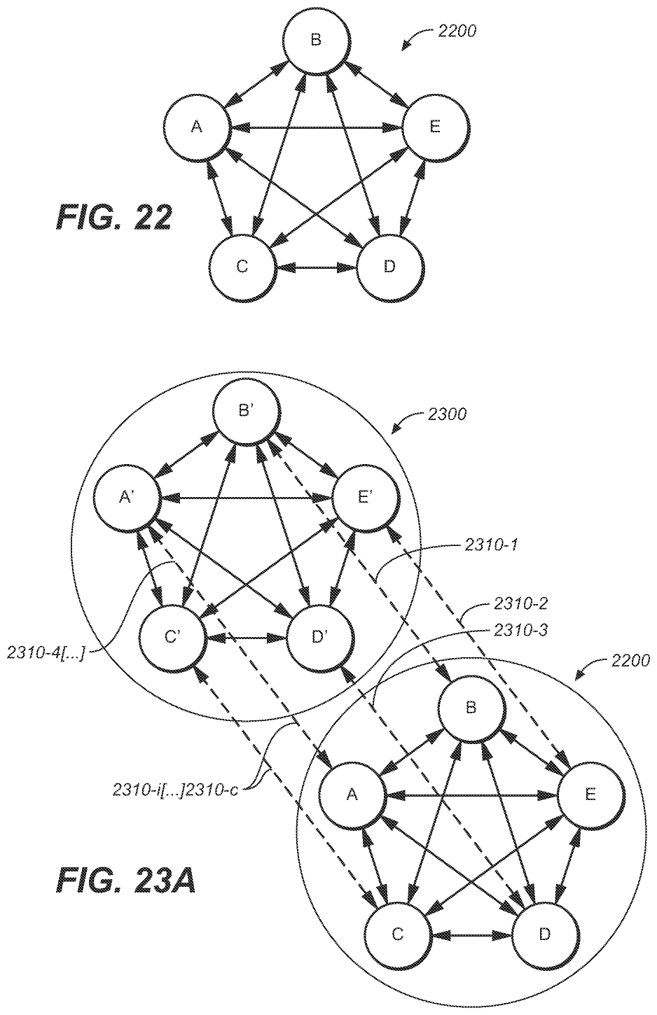

FIG. 22 illustrates the basic structure of an exemplary network 2200 created using the above implementation of the Node Layer tool. A network created by this tool will vary in size (i.e. number of nodes), based on how many nodes are requested.

3) Node Block

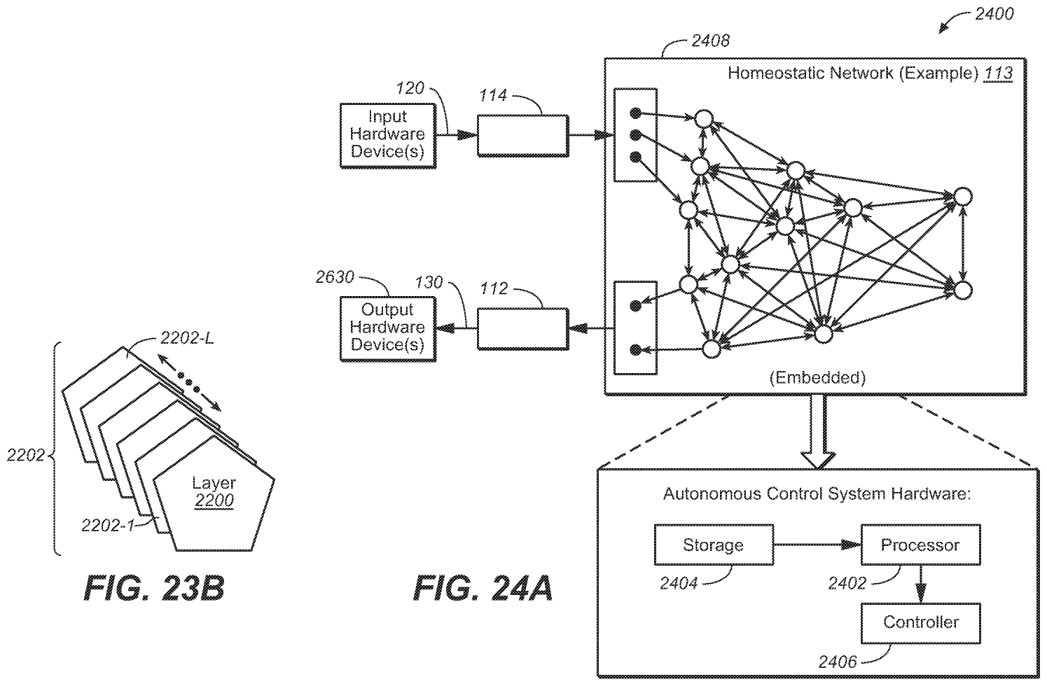

FIGS. 23A and 23B illustrate how Layers would be connected in one implementation: In this example aspect, a Node Block software class builds upon the Node Layer implementation above to construct a plurality 2202 of L layers 2200-1, [ . . . ], 2300-L. To create a Block, one aspect allocates a sequence of Layers, and connects them in a one-to-one node relationship (not fully connected) represented by a plurality 2310 of connections (2310-1, [ . . . ] 2310-c). FIG. 23B illustrates how a stack 2202 of layers may then be created in allocating homeostatic networks of several aspects of the described subject matter. Basic pseudocode (in Python) for a Node Block of one aspect of the described subject matter is set forth below:

class Block:

def_{——}init_{——}(self, numLayers, node_allocator):

self.layers = Layer[..] from node_allocator
self.num_layers = numLayers
# connect all the nodes to each other
for I in range(self.num_layers−1):

ConnectLayers(self.layers[i], self.layers[i+1])

def ConnectLayers(self, layer_1, layer_2):

layer_size = layer_1.GetSize( )
for index in range(layer_size):

layer_1.GetNode(index).Connect(layer_2.GetNode(index)
layer_2.GetNode(index).Connect(layer_1.GetNode(index)

def GetNumLayers(self):

return self.num_layers

def GetLayer(self, index):

return self.layers[index]

In some aspects, Layers in a Block can also be connected fully, which has slightly different network topology. In such aspects, pseudocode for fully-connected Layers in Blocks may be similar to the above, but with a modified ConnectLayers( ) function, such as:

def ConnectLayersFully(self, layer_1, layer_2):

layer_size = layer_1.GetSize( )
for index_1 in range(layer_size):

for index_2 in range(layer_size):

layer_1.GetNode(index_1).Connect(layer_2).GetNode(index_2)
layer_2.GetNode(index_2).Connect(layer_1).GetNode(index_1)

K. Hardware Implementation

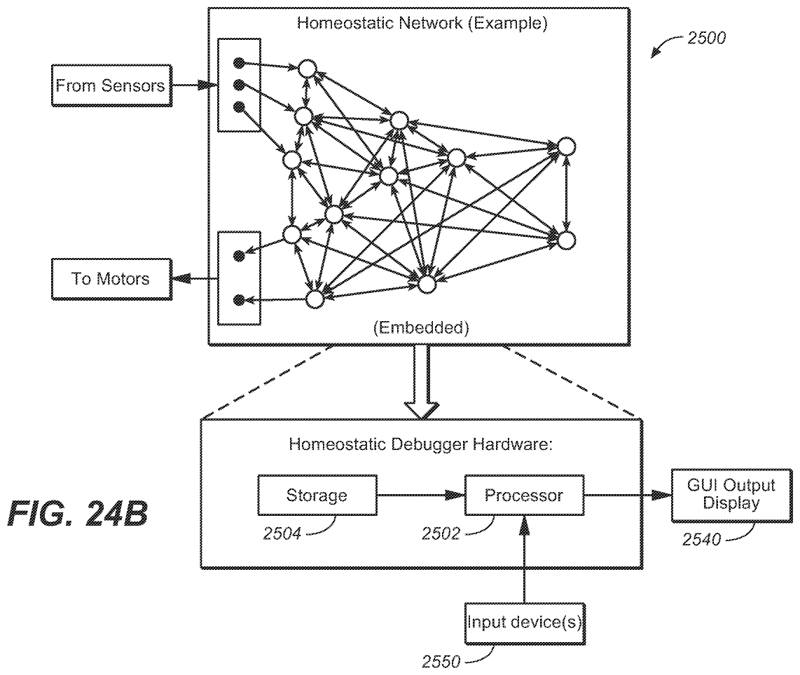

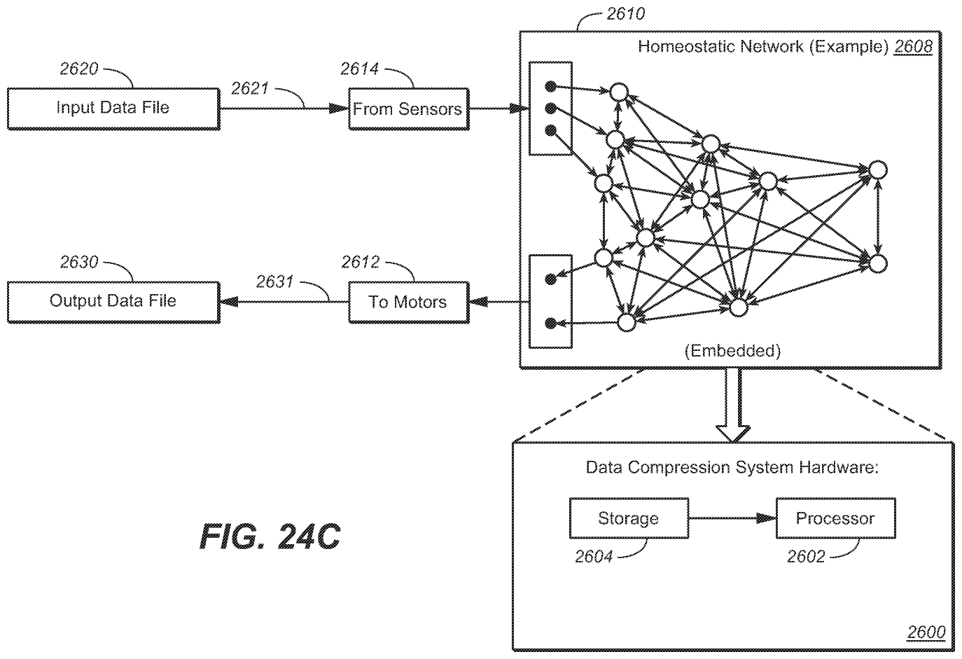

The techniques described above can be implemented as computer software using computer-readable instructions and physically stored in one or more computer-readable media, as, for example, in a computer system, as in examples shown in FIGS. 24A, 24B and 24C, which are suitable for implementing certain aspects of the disclosed subject matter. (Firmware and/or circuitry may also incorporate various aspects of the disclosed subject matter.) The computer software can be coded using any suitable machine code or computer language that may be subject to assembly, compilation, linking, or like mechanisms to create code comprising instructions that can be executed directly, or through interpretation, micro-code execution, and the like, by one or more computer processing units (e.g., CPUs), Graphics Processing Units (GPUs), and the like. The instructions can be executed on various types of computers or components thereof, including, for example, computers embedded in various autonomous control systems, robotics systems, internet of things devices, controllers, natural language processing systems, computer vision systems, and others systems or devices adapted for other related processes, such as data compression, anomaly detection, prediction systems, and the like. Physical input and output devices, which generate input(s) to the sensor(s) and receive output(s) from the motor(s) of sensorium 110, respectively, are also shown (see FIG. 24A).

The components shown in schematic illustrations of computer systems (FIGS. 24A, 24B, and 24C) are exemplary in nature and are not intended to suggest any limitation as to the scope of use or functionality of the computer software, firmware, and/or circuitry implementing aspects of the present disclosure. Neither should the configuration of components be interpreted as having any dependency or requirement relating to any one or combination of components illustrated in the exemplary implementation of these computer systems for the subject matter described herein. The number of network nodes and interconnections between them are shown for illustration purposes only; the illustrations are schematic, and are not intended to restrict or limit the numbers of nodes and/or interconnections to precise counts.

FIG. 24A is a schematic diagram of a data processing system 2400 for one example implementation of the subject matter described herein. In this aspect, data processing system comprises: a computer processor 2402; a computer-readable storage medium 2404 informationally coupled to the computer processor 2402; a controller 2406 informationally coupled to computer processor 2402; and executable code 2408 embodied in the computer-readable storage medium 2404 for execution by the computer processor 2402, wherein the executable code 2408 comprises a data structure 2409 implementing a sensorium 2410 informationally coupled to a controller 2406, and wherein the controller 2406 is operable to generate a set of real-time adaptive control signals 2430 in response to changes in an operating environment 100. Optionally, as described above, data processing system 2400 may further comprise modulating signals in the sensorium 110.

In one aspect, controller 2406 of data processing system 2400 may provide an autonomous stability control system within operating environment 100, as in, for example, solving the “Cartpole problem” as described above.

FIG. 24B is a schematic of basic hardware components suitable for implementing aspects of a homeostatic network debugger apparatus 2500 according to the subject matter disclosed herein. In this aspect, homoestatic debugger includes: a computer processor (2502); a computer-readable storage medium (2504) informationally coupled to the computer processor (2502); and a graphical user interface (2540) informationally coupled to the computer processor (2502). Graphical user interface generates a homeostat display (2510), a sensor and motor display (2512), a set of simulation time controls (2514), a network layout render (2516), and an environment display window (2518), as shown, for example, in FIG. 16, FIG. 17 and FIG. 18, described above.

FIG. 24C is a schematic of basic hardware components suitable for implementing aspects of a data processing system 2600 as described. In this aspect, data processing system 2600 includes: a computer processor 2602; a computer-readable storage medium 2604 informationally coupled to the computer processor 2602; executable code 2608 embodied in the computer-readable storage medium 2604 for execution by computer processor 2602, wherein executable code 2608 comprises a data structure (for example, as shown in FIG. 3B, FIG. 3C and FIG. 21) implementing a sensorium 2610 informationally coupled to an input data file 2320 and an output data file 2630. In this aspect, a set of real-time adaptive control signals 2631 is operable to effect data compression of a set of sequential input data signals 2621 from an input data file 2620 within the operating environment 100, thereby generating a compressed output data file 2630. Input data file 2620 may include, for example, set of sequential input data signals comprises a natural language data stream, sensor data, an audio signal, or an image signal.

In general, a computer system for implementing certain aspects of the described subject matter may include certain human interface input devices responsive to input by one or more human users; it may also include certain human interface output devices. A suitable computer system for implementing aspects of the described subject matter can also include an interface to one or more communication networks (not shown). The computer readable media (storage) can have computer code thereon for performing various computer-implemented operations. The media and computer code can be those specially designed and constructed for the purposes of the present disclosure, or they can be of the kind well known and available to those having skill in the computer software arts. The present disclosure encompasses any suitable combination of hardware and software for implementing aspects of the subject matter described herein.

### GLOSSARY OF TERMS

Auto Associative Behavior Recall: Auto-associative behavior recall is a form of auto-associative memory where a sequence of behavior over time is “recalled” in fullness when a similar sequence of behaviors is initiated. See Auto-Associative Memory

Auto-Associative Memory: Auto-associative memory, also known as auto-association memory or an auto-association network, is any type of memory that enables one to retrieve a piece of data from a tiny sample of itself. Auto-associative memories are capable of retrieving data upon presentation of partial information from that piece of data.

Accumulated Prediction Error: When iterated over time, a local prediction error is accumulated and stored. Accumulated Prediction Error is a measure of the difference between a local model of the world and what is locally sensed, with associated perceptions.

Cellular Automata: Cellular Automaton is a discrete model studied in a variety of fields such as Computer Science, Mathematics, Physics, Complexity Science, Theoretical Biology and Microstructure modeling. Cellular Automata are also called “Cellular Spaces,” “Tessellation Automata,” “Homogenous Structures,” “Cellular Structures,” “Tessellation Structures” and “Iterative Arrays.” In the context of homeostatic networks of the present subject matter, a general framework of a Cellular Automata inspires the design of the homeostatic network; however, in a homeostatic network, Cellular Automata rules are replaced with chaotic attractors implementing ultrastability.

Chaotic Attractor (also known as Strange Attractor): In the field of dynamical systems, an attractor can be described as a set of numerical values toward which a system tends to evolve, for a wide variety of starting conditions of the system. System values that get close enough to the attractor values remain close even if slightly disturbed. In finite-dimensional systems, the evolving variable may be represented algebraically as an n-dimensional vector. The attractor is a region in n-dimensional space. In physical systems, the n dimensions may be, for example, two or three positional coordinates for each of one or more physical entities. In the context of a homeostatic network, network nodes are implementing ultrastability as a Chaotic Attractor.

Critical State (also known as a critical point): In the context of a homeostatic network, the network dynamics are in a critical state when a phase equilibrium curve is followed in such a way that the network can change state very quickly when disturbed.

Data Source: This is a source of data to be compressed, such as a computer audio data file, which can be fed into the Sequential Data Sensorimotor Harness.

Environment: The Environment is meant to be general, but can be considered an interactive medium in which an agent exists and operates.

Environment State: The Environment state is some kind of representation of the state of the environment, usually as a collection of data about the Environment.

Generative Model: A generative model is a predictive model that generates predictions by building a model of its environment. This is in contrast to a discriminative model: A discriminative model models the decision boundary between classes, whereas a generative model explicitly models the actual distribution of each class.

Holon: A holon is something that is simultaneously a whole and a part, and also can be a member of a Holarchy (see Holarchy).

Holonic: Pertaining to holons; involving something that is simultaneously a self-contained entity and a part of a larger system. (See Holarchy)

Holarchy: A holarchy is a hierarchy of holons. A holarchy is similar to a hierarchy, except that the parent-child relationship in a holoarchy is constitutive, such that the parent is constituted of the children as opposed to separate from the children (as in a hierarchy). A holarchy is a more bottom-up construction of relationships than a hierarchy, though similar in structure. The “hierarchical relationship” between holons is that holons at one level are “made up of, or make up” the holons or parts of another level. The parts only exist as they are integrated to create the whole and the whole's definition is that of the parts.

Homeostasis: Homeostasis refers the tendency of a system to maintain stability, owing to the coordinated response of its parts to any situation or external stimulus that would tend to disturb the system's operating condition or function. Any self-regulating process by which a systems tends to maintain stability while adjusting to conditions pertinent to survival. The stability so maintained is actually a dynamic equilibrium, in which continuous change occurs, yet relatively uniform conditions prevail. The property of ultrastability is but one mechanism capable of generating homeostasis.

Homeostat: As used herein, a homeostat is a network node in a network capable of achieving ultrastability.

Homeostatic Dynamics: Homeostatic dynamics describe the generated dynamics of a homeostatic network during interaction with an environment.

Homeostatic Network: In the context of the described subject matter, a homeostatic network is a network of nodes, wherein each of the nodes uses ultrastability to generate a state of homeostasis.

Incoming Sensor Signal: Within a sensorium, when a sensor is connected to a homeostatic network node, the incoming sensor signal is the value presented to the homeostatic network.

Motor: As used herein, a “motor” of a sensorium defines an interface between an operating environment and a homeostatic network. The motor samples (retrieves the current value of) the state of a node in the homeostatic network and uses it to affect a change in operating environment.

Neighbor (Neighboring) Nodes: Within a homeostatic network, neighboring nodes are nodes that are directly connected to each other.

Outgoing Signal: Within a homeostatic network, the outgoing signal is simply the accumulated prediction error value stored in a particular node. When there is a direct connection between two nodes, the outgoing signal from one node is an incoming signal to the other node.

Self-Perpetuation: In the context of the described subject matter, self-perpetuation of weights and signals are implicitly rewarded. The network update process is a selective process that iteratively discards bad weight values, and filters out irrelevant signals. The weights and signals that remain are the results of this selective process, and can be thought of as self-perpetuating, as they exhibit the behavior advantageous to replicate their own existence.

Sensor: As used herein, a “sensor” of a sensorium defines an interface between an operating environment and a homeostatic network. The sensor samples environment state information and generates an input signal to provide to a node in the homeostatic network.

Sensorium: A sensorium comprises at least one sensor and at least one motor, as those terms are generally defined herein, and a network of nodes informationally coupled to the sensorium's sensor(s) and motor(s). In the context of the described subject matter, a sensorium interfaces with an operating environment via at least one sensor and at least one motor, as those terms are generally defined.

Set: As used herein, a set of elements refers to one or more elements. For example, a “set of motors” refers to one or more motors, a “set of sensors” refers to one or more sensors, a “set of connections” refers to one or more connections, etc.

Ultrastable: Having the property of ultrastability. See Ultrastability

Ultrastability: Ultrastability refers to the ability of a system to modify internal relationships among its constituents, and/or to influence environmental conditions, in order to neutralize actual or potential destabilizing events or obstacles within (or relating to) an operating environment, thereby maintaining stability. Maintaining stability, in the context of the described subject matter, implies keeping accumulated prediction error within a threshold value. Ultrastability also refers to the ability of a system to change its internal organization or structure in response to environmental conditions that threaten to disturb a desired (control) behavior or value of a variable.

What is claimed is:

1. A method of implementing a machine-learning control system, the method comprising:
identifying, in a data processing system, an operating environment comprising a set of environmental parameters and a control behavior;
defining, in the data processing system, a sensorium informationally coupled to the set of environmental parameters within the operating environment, wherein the sensorium comprises at least one motor and at least one sensor; and
informationally coupling, in the data processing system, a homeostatic network to the at least one sensor and to the at least one motor, wherein the homeostatic network comprises a plurality of nodes, where the homeostatic network is operable to achieve ultrastability associated with the control behavior within the operating environment.

2. The method of claim 1, further comprising modulating signals in the sensorium.

3. The method of claim 1, further comprising defining an update rate of the sensorium.

4. The method of claim 1, wherein at least one node in the plurality of nodes is individually configured to achieve ultrastability within the operating environment.

5. The method of claim 1, further comprising:
training the homeostatic network by sampling, in the data processing system, a local state information signal of at least
one node in the homeostatic network,
generating, in the data processing system, a motor signal based upon the local state information signal, wherein the motor signal is operable to affect a change in the operating environment,
sampling, in the data processing system, an environment state information signal relating to the set of environmental parameters and the control behavior, and
generating, in the data processing system, a sensor signal based upon the environment state information signal, wherein the sensor signal is operable to update the plurality of nodes in the homeostatic network.

6. The method of claim 5,
wherein the plurality of nodes comprises a data structure comprising a list operable to store a set of connected nodes and a corresponding set of connection weights, and a memory location operable to store an accumulated prediction error computed from the corresponding set of connection weights, and
wherein, during training, the accumulated prediction error is used by the at least one motor to determine the local state information signal of the at least one node.

7. The method of claim 5, further comprising modulating signals in the sensorium during training.

8. The method of claim 7, wherein modulating signals in the sensorium comprises using a sensorimotor carrier wave signal operable to generate the sensor signal through a modulation process.

9. The method of claim 7, wherein modulating signals the sensorium comprises using a sensorimotor carrier wave signal operable to generate the motor signal through a demodulation process.

10. An autonomous control system comprising:
a computer processor;
a computer-readable hardware storage medium informationally coupled to the computer processor; and
program code embodied in the computer-readable hardware storage medium for execution by the computer processor to implement a method for achieving autonomous control, the method comprising
identifying an operating environment comprising a set of environmental parameters, a control behavior, and an environment state information signal,
defining a sensorium informationally coupled to the operating environment, wherein the sensorium comprises
a network comprising a plurality of nodes operable to achieve ultrastability within the operating environment,
at least one motor informationally coupled to the network and the operating environment, and operable to affect the control behavior, and
at least one sensor informationally coupled to the network and the operating environment, and operable to sample the environment state information signal of the operating environment,
updating the environment state information signal of the operating environment in response to at least one motor signal generated by the at least one motor, and
updating the sensorium in response to at least one sensor signal generated by the at least one sensor in response to updating the environment state information signal of the operating environment.

11. The autonomous control system of claim 10, further comprising at least one sensorimotor carrier wave signal operable to modulate signals in the sensorium.

12. The autonomous control system of claim 10, wherein the sensorium further comprises an update rate relative to the operating environment.

13. The autonomous control system of claim 10, further comprising means for updating the network.

14. A non-transitory computer-readable medium having stored thereon computer-executable instructions which, when executed by an information processing device, cause the information processing device to provide a set of real-time adaptive control signals in an autonomous control system through an active inference process.

15. The non-transitory computer-readable medium of claim 14, wherein the active inference process performs a method comprising:
initializing randomly a node in a network to determine a local predictive model of an operating environment;
evaluating the local predictive model based upon an accumulated prediction error computed at the node;
determining whether the local predictive model causes the accumulated prediction error at the node to exceed a threshold value; and
generating a set of random connection weights when the accumulated prediction error at the node exceeds the threshold value.

16. The non-transitory computer-readable medium of claim 15, wherein the network is a homeostatic network.

17. A data processing system comprising:
a computer processor;
a computer-readable storage medium informationally coupled to the computer processor;
a controller informationally coupled to the computer processor; and
executable code embodied in the computer-readable storage medium for execution by the computer processor, wherein the executable code comprises a data structure implementing a sensorium informationally coupled to a controller, and wherein the controller is operable to generate a set of real-time adaptive control signals in response to changes in an operating environment.

18. The data processing system of claim 17, further comprising modulating signals in the sensorium.

19. The data processing system of claim 17, wherein the operating environment comprises an autonomous stability control system.

20. A homeostatic network debugger apparatus comprising:
a computer processor;
a computer-readable storage medium informationally coupled to the computer processor; and
a graphical user interface informationally coupled to the computer processor, wherein the graphical user interface comprises executable code embodied in the computer-readable storage medium for execution by the computer processor, operable to generate a homeostat display, a sensor and motor display, a set of simulation time controls, a network layout render, and an environment display window.

21. An autonomous control system comprising a computer processor, a computer-readable hardware storage medium, and program code embodied in the computer-readable hardware storage medium for execution by the computer processor to implement a machine-learning method comprising:
generating a data structure representing a plurality of nodes in a network of nodes;
generating at least one split condition signal relating to a node in the plurality of nodes; and
performing at least one split function conditionally upon the at least one split condition signal, so as to generate at least one additional node in the plurality of nodes.
